(19) United States
(12) Patent Application Publication
(10) Pub. No.: US 2025/0392960 A1
(43) Pub. Date: Dec. 25, 2025

(54) COORDINATED SCHEDULING-BASED PROTOCOLS FOR MULTI-HOP TRAFFIC FLOWS IN A CONTROLLER-BASED NETWORK

(71) Applicant: QUALCOMM Incorporated, San Diego, CA (US)

(72) Inventors: Xiaolong HUANG, Santee, CA (US); Gyanranjan HAZARIKA, Milpitas, CA (US); Sandip HOMCHAUDHURI, San Jose, CA (US); Manish SHUKLA, Milpitas, CA (US)

(21) Appl. No.: 18/748,067

(22) Filed: Jun. 19, 2024

(51) Int. Cl. H04W 28/10; H04L 45/00; H04L 47/17; H04W 28/02

(52) U.S. Cl. CPC H04W 28/10; H04L 47/17; H04W 28/0273

(57) ABSTRACT

This disclosure provides methods, components, devices and systems for coordinated scheduling-based protocols for multi-hop traffic flows in a controller-based network. Some aspects more specifically relate to a coordinated scheduling of time slots for multi-hop traffic flows across both fronthaul and backhaul links in controller-based networks. In some examples, an access point (AP) within the network may provide information indicative of one or more established schedules of time slots to a network controller and the network controller may use such information for conflict resolution between different schedules of time slots. In accordance with the propagation of schedules of time slots to the network controller, the network controller may obtain a complete view of traffic patterns within the network and leverage such a complete view for the conflict resolution. Additionally, or alternatively, an AP may rely on a configuration by the network controller of one or more coordinated schedules of time slots.

### TECHNICAL FIELD

This disclosure relates generally to wireless communication and, more specifically, to coordinated scheduling-based protocols for multi-hop traffic flows in a controller-based network.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless access point (AP). The first wireless AP may include a processing system that includes processor circuitry and memory circuitry that stores code. The processing system may be configured to cause the first wireless AP to transmit a first message to establish one or more first time slots associated with a first communication of a first traffic flow between the first wireless AP and a first wireless station (STA) associated with the first wireless AP, where the one or more first time slots are associated with a coordinated scheduling-based protocol, transmit a second message associated with an advertisement of the one or more first time slots, and transmit, to a network controller, a third message that indicates the one or more first time slots in accordance with the advertisement of the one or more first time slots.

Another innovative aspect of the subject matter described in this disclosure can be implemented in a method for wireless communication by or at a first wireless AP. The method may include transmitting a first message to establish one or more first time slots associated with a first communication of a first traffic flow between the first wireless AP and a first wireless STA associated with the first wireless AP, where the one or more first time slots are associated with a coordinated scheduling-based protocol, transmitting a second message associated with an advertisement of the one or more first time slots, and transmitting, to a network controller, a third message that indicates the one or more first time slots in accordance with the advertisement of the one or more first time slots.

Another innovative aspect of the subject matter described in this disclosure can be implemented in a first wireless AP. The first wireless AP may include means for transmitting a first message to establish one or more first time slots associated with a first communication of a first traffic flow between the first wireless AP and a first wireless STA associated with the first wireless AP, where the one or more first time slots are associated with a coordinated scheduling-based protocol, means for transmitting a second message associated with an advertisement of the one or more first time slots, and means for transmitting, to a network controller, a third message that indicates the one or more first time slots in accordance with the advertisement of the one or more first time slots.

Another innovative aspect of the subject matter described in this disclosure can be implemented in a non-transitory computer-readable medium storing code for wireless communication by or at a first wireless AP. The code may include instructions executable by a processing system to transmit a first message to establish one or more first time slots associated with a first communication of a first traffic flow between the first wireless AP and a first wireless STA associated with the first wireless AP, where the one or more first time slots are associated with a coordinated scheduling-based protocol, transmit a second message associated with an advertisement of the one or more first time slots, and transmit, to a network controller, a third message that indicates the one or more first time slots in accordance with the advertisement of the one or more first time slots.

Some examples of the method, first wireless APs, and non-transitory computer-readable medium described herein may further include operations, features, means, or instructions for transmitting, to a second wireless AP, a request for the second wireless AP to establish time slots associated with a second communication of the first traffic flow between the first wireless AP and the second wireless AP and receiving, from the second wireless AP, an indication of one or more second time slots associated with the second communication of the first traffic flow between the first wireless AP and the second wireless AP in association with transmitting the request, where the one or more second time slots may be associated with the coordinated scheduling-based protocol.

In some examples of the method, first wireless APs, and non-transitory computer-readable medium described herein, the second wireless AP may be a root AP associated with a network of wireless APs including the first wireless AP and the second wireless AP.

Some examples of the method, first wireless APs, and non-transitory computer-readable medium described herein may further include operations, features, means, or instructions for transmitting, to the network controller, information indicative of one or more requested time slots associated with a second communication of the first traffic flow between the first wireless AP and a second wireless AP and receiving, from the second wireless AP, an indication of one or more second time slots associated with the second communication of the first traffic flow between the first wireless AP and the second wireless AP in association with transmitting the information indicative of the one or more requested time slots, where the one or more second time slots may be associated with the coordinated scheduling-based protocol.

In some examples of the method, first wireless APs, and non-transitory computer-readable medium described herein, the one or more second time slots may be advertised by the second wireless AP in accordance with the coordinated scheduling-based protocol and the second wireless AP may be a root AP associated with a network of wireless APs including the first wireless AP and the second wireless AP.

Another innovative aspect of the subject matter described in this disclosure can be implemented in a network controller. The network controller may include a processing system that includes processor circuitry and memory circuitry that stores code. The processing system may be configured to cause the network controller to receive a first message that indicates one or more first time slots associated with a first communication of a first traffic flow between a first wireless AP and a first wireless STA associated with the first wireless AP, where the one or more first time slots are associated with a coordinated scheduling-based protocol, receive a second message that indicates one or more requested time slots associated with a second communication of a second traffic flow between a second wireless AP and a second wireless STA associated with the second wireless AP, where the one or more requested time slots are associated with the coordinated scheduling-based protocol, and transmit, in accordance with a conflict between the one or more first time slots and the one or more requested time slots, a third message that indicates a time-domain adjustment to the one or more first time slots or the one or more requested time slots in accordance with a first priority associated with the first traffic flow and a second priority associated with the second traffic flow.

Another innovative aspect of the subject matter described in this disclosure can be implemented in a method for wireless communication by or at a network controller. The method may include receiving a first message that indicates one or more first time slots associated with a first communication of a first traffic flow between a first wireless AP and a first wireless STA associated with the first wireless AP, where the one or more first time slots are associated with a coordinated scheduling-based protocol, receiving a second message that indicates one or more requested time slots associated with a second communication of a second traffic flow between a second wireless AP and a second wireless STA associated with the second wireless AP, where the one or more requested time slots are associated with the coordinated scheduling-based protocol, and transmitting, in accordance with a conflict between the one or more first time slots and the one or more requested time slots, a third message that indicates a time-domain adjustment to the one or more first time slots or the one or more requested time slots in accordance with a first priority associated with the first traffic flow and a second priority associated with the second traffic flow.

Another innovative aspect of the subject matter described in this disclosure can be implemented in a network controller. The network controller may include means for receiving a first message that indicates one or more first time slots associated with a first communication of a first traffic flow between a first wireless AP and a first wireless STA associated with the first wireless AP, where the one or more first time slots are associated with a coordinated scheduling-based protocol, means for receiving a second message that indicates one or more requested time slots associated with a second communication of a second traffic flow between a second wireless AP and a second wireless STA associated with the second wireless AP, where the one or more requested time slots are associated with the coordinated scheduling-based protocol, and means for transmitting, in accordance with a conflict between the one or more first time slots and the one or more requested time slots, a third message that indicates a time-domain adjustment to the one or more first time slots or the one or more requested time slots in accordance with a first priority associated with the first traffic flow and a second priority associated with the second traffic flow.

Another innovative aspect of the subject matter described in this disclosure can be implemented in a non-transitory computer-readable medium storing code for wireless communication by or at a network controller. The code may include instructions executable by a processing system to receive a first message that indicates one or more first time slots associated with a first communication of a first traffic flow between a first wireless AP and a first wireless STA associated with the first wireless AP, where the one or more first time slots are associated with a coordinated scheduling-based protocol, receive a second message that indicates one or more requested time slots associated with a second communication of a second traffic flow between a second wireless AP and a second wireless STA associated with the second wireless AP, where the one or more requested time slots are associated with the coordinated scheduling-based protocol, and transmit, in accordance with a conflict between the one or more first time slots and the one or more requested time slots, a third message that indicates a time-domain adjustment to the one or more first time slots or the one or more requested time slots in accordance with a first priority associated with the first traffic flow and a second priority associated with the second traffic flow.

In some examples of the method, network controllers, and non-transitory computer-readable medium described herein, the time-domain adjustment to the one or more first time slots or the one or more requested time slots includes a first time-domain adjustment to the one or more first time slots in accordance with the first priority being higher than the second priority or a second time-domain adjustment to the one or more requested time slots in accordance with the second priority being higher than the first priority.

Some examples of the method, network controllers, and non-transitory computer-readable medium described herein may further include operations, features, means, or instructions for transmitting, to the first wireless AP, an indication of the first time-domain adjustment to the one or more first time slots or transmitting, to the second wireless AP, an indication of the second time-domain adjustment to the one or more requested time slots.

In some examples of the method, network controllers, and non-transitory computer-readable medium described herein, the network controller stores information indicative of the one or more first time slots and the first priority associated with the first traffic flow in one or more memories associated with the network controller in accordance with the coordinated scheduling-based protocol and the coordinated scheduling-based protocol may be associated with a mediation of time slot allocations across a set of multiple wireless APs at the network controller.

Another innovative aspect of the subject matter described in this disclosure can be implemented in a first wireless AP. The first wireless AP may include a processing system that includes processor circuitry and memory circuitry that stores code. The processing system may be configured to cause the first wireless AP to transmit a first message that indicates a request for one or more coordinated time slots associated with a first communication of a first traffic flow between the first wireless AP and a first wireless STA associated with the first wireless AP, receive a second message that indicates one or more first time slots associated with the first communication of the first traffic flow between the first wireless AP and the first wireless STA in accordance with the request, where the one or more first time slots are associated with a coordinated scheduling-based protocol, and transmit a third message associated with an advertisement of the one or more first time slots in accordance with receiving the second message.

Another innovative aspect of the subject matter described in this disclosure can be implemented in a method for wireless communication by or at a first wireless AP. The method may include transmitting a first message that indicates a request for one or more coordinated time slots associated with a first communication of a first traffic flow between the first wireless AP and a first wireless STA associated with the first wireless AP, receiving a second message that indicates one or more first time slots associated with the first communication of the first traffic flow between the first wireless AP and the first wireless STA in accordance with the request, where the one or more first time slots are associated with a coordinated scheduling-based protocol, and transmitting a third message associated with an advertisement of the one or more first time slots in accordance with receiving the second message.

Another innovative aspect of the subject matter described in this disclosure can be implemented in a first wireless AP. The first wireless AP may include means for transmitting a first message that indicates a request for one or more coordinated time slots associated with a first communication of a first traffic flow between the first wireless AP and a first wireless STA associated with the first wireless AP, means for receiving a second message that indicates one or more first time slots associated with the first communication of the first traffic flow between the first wireless AP and the first wireless STA in accordance with the request, where the one or more first time slots are associated with a coordinated scheduling-based protocol, and means for transmitting a third message associated with an advertisement of the one or more first time slots in accordance with receiving the second message.

Another innovative aspect of the subject matter described in this disclosure can be implemented in a non-transitory computer-readable medium storing code for wireless communication by or at a first wireless AP. The code may include instructions executable by a processing system to transmit a first message that indicates a request for one or more coordinated time slots associated with a first communication of a first traffic flow between the first wireless AP and a first wireless STA associated with the first wireless AP, receive a second message that indicates one or more first time slots associated with the first communication of the first traffic flow between the first wireless AP and the first wireless STA in accordance with the request, where the one or more first time slots are associated with a coordinated scheduling-based protocol, and transmit a third message associated with an advertisement of the one or more first time slots in accordance with receiving the second message.

Some examples of the method, first wireless APs, and non-transitory computer-readable medium described herein may further include operations, features, means, or instructions for receiving a fourth message that indicates one or more second time slots associated with a second communication of the first traffic flow between the first wireless AP and a second wireless AP, where the one or more second time slots may be associated with the coordinated scheduling-based protocol.

Some examples of the method, first wireless APs, and non-transitory computer-readable medium described herein may further include operations, features, means, or instructions for communicating, with the first wireless STA, one or more first packets associated with the first traffic flow within the one or more first time slots and communicating, with the second wireless AP, one or more second packets associated with the first traffic flow within the one or more second time slots.

Another innovative aspect of the subject matter described in this disclosure can be implemented in a network controller. The network controller may include a processing system that includes processor circuitry and memory circuitry that stores code. The processing system may be configured to cause the network controller to receive a first message that indicates a request for one or more coordinated time slots associated with a first communication of a first traffic flow between a first wireless AP and a first wireless STA associated with the first wireless AP, transmit a second message that indicates one or more first time slots associated with the first communication of the first traffic flow between the first wireless AP and the first wireless STA, where the one or more first time slots are associated with a coordinated scheduling-based protocol, and transmit a third message that indicates one or more second time slots associated with a second communication of the first traffic flow between the first wireless AP and a second wireless AP, where the one or more second time slots are associated with the coordinated scheduling-based protocol.

Another innovative aspect of the subject matter described in this disclosure can be implemented in a method for wireless communication by or at a network controller. The method may include receiving a first message that indicates a request for one or more coordinated time slots associated with a first communication of a first traffic flow between a first wireless AP and a first wireless STA associated with the first wireless AP, transmitting a second message that indicates one or more first time slots associated with the first communication of the first traffic flow between the first wireless AP and the first wireless STA, where the one or more first time slots are associated with a coordinated scheduling-based protocol, and transmitting a third message that indicates one or more second time slots associated with a second communication of the first traffic flow between the first wireless AP and a second wireless AP, where the one or more second time slots are associated with the coordinated scheduling-based protocol.

Another innovative aspect of the subject matter described in this disclosure can be implemented in a network controller. The network controller may include means for receiving a first message that indicates a request for one or more coordinated time slots associated with a first communication of a first traffic flow between a first wireless AP and a first wireless STA associated with the first wireless AP, means for transmitting a second message that indicates one or more first time slots associated with the first communication of the first traffic flow between the first wireless AP and the first wireless STA, where the one or more first time slots are associated with a coordinated scheduling-based protocol, and means for transmitting a third message that indicates one or more second time slots associated with a second communication of the first traffic flow between the first wireless AP and a second wireless AP, where the one or more second time slots are associated with the coordinated scheduling-based protocol.

Another innovative aspect of the subject matter described in this disclosure can be implemented in a non-transitory computer-readable medium storing code for wireless communication by or at a network controller. The code may include instructions executable by a processing system to receive a first message that indicates a request for one or more coordinated time slots associated with a first communication of a first traffic flow between a first wireless AP and a first wireless STA associated with the first wireless AP, transmit a second message that indicates one or more first time slots associated with the first communication of the first traffic flow between the first wireless AP and the first wireless STA, where the one or more first time slots are associated with a coordinated scheduling-based protocol, and transmit a third message that indicates one or more second time slots associated with a second communication of the first traffic flow between the first wireless AP and a second wireless AP, where the one or more second time slots are associated with the coordinated scheduling-based protocol.

Some examples of the method, network controllers, and non-transitory computer-readable medium described herein may further include operations, features, means, or instructions for receiving, via the first message, timing information associated with the first traffic flow, where the one or more first time slots or the one or more second time slots, or both, may be in accordance with the timing information associated with the first traffic flow.

Another innovative aspect of the subject matter described in this disclosure can be implemented in a first wireless AP. The first wireless AP may include a processing system that includes processor circuitry and memory circuitry that stores code. The processing system may be configured to cause the first wireless AP to receive a first message that indicates one or more first time slots associated with a first communication of a first traffic flow between a second wireless AP and a wireless STA associated with the second wireless AP, where the one or more first time slots are associated with a coordinated scheduling-based protocol, receive, from a network controller, a second message that indicates one or more second time slots associated with a second communication of the first traffic flow between the first wireless AP and the second wireless AP, where the one or more second time slots are associated with the coordinated scheduling-based protocol, and transmit a second message associated with an advertisement of the one or more second time slots.

Another innovative aspect of the subject matter described in this disclosure can be implemented in a method for wireless communication by or at a first wireless AP. The method may include receiving a first message that indicates one or more first time slots associated with a first communication of a first traffic flow between a second wireless AP and a wireless STA associated with the second wireless AP, where the one or more first time slots are associated with a coordinated scheduling-based protocol, receiving, from a network controller, a second message that indicates one or more second time slots associated with a second communication of the first traffic flow between the first wireless AP and the second wireless AP, where the one or more second time slots are associated with the coordinated scheduling-based protocol, and transmitting a second message associated with an advertisement of the one or more second time slots.

Another innovative aspect of the subject matter described in this disclosure can be implemented in a first wireless AP. The first wireless AP may include means for receiving a first message that indicates one or more first time slots associated with a first communication of a first traffic flow between a second wireless AP and a wireless STA associated with the second wireless AP, where the one or more first time slots are associated with a coordinated scheduling-based protocol, means for receiving, from a network controller, a second message that indicates one or more second time slots associated with a second communication of the first traffic flow between the first wireless AP and the second wireless AP, where the one or more second time slots are associated with the coordinated scheduling-based protocol, and means for transmitting a second message associated with an advertisement of the one or more second time slots.

Another innovative aspect of the subject matter described in this disclosure can be implemented in a non-transitory computer-readable medium storing code for wireless communication by or at a first wireless AP. The code may include instructions executable by a processing system to receive a first message that indicates one or more first time slots associated with a first communication of a first traffic flow between a second wireless AP and a wireless STA associated with the second wireless AP, where the one or more first time slots are associated with a coordinated scheduling-based protocol, receive, from a network controller, a second message that indicates one or more second time slots associated with a second communication of the first traffic flow between the first wireless AP and the second wireless AP, where the one or more second time slots are associated with the coordinated scheduling-based protocol, and transmit a second message associated with an advertisement of the one or more second time slots.

Some examples of the method, first wireless APs, and non-transitory computer-readable medium described herein may further include operations, features, means, or instructions for receiving, from the second wireless AP, a third message that includes timing information associated with the first traffic flow and transmitting, to the network controller, a fourth message that includes an indication of one or more requested time slots associated with the second communication of the first traffic flow between the first wireless AP and the second wireless AP in association with receiving the third message from the second wireless AP, where receiving the second message that indicates the one or more second time slots may be in association with transmitting the fourth message to the network controller.

Some examples of the method, first wireless APs, and non-transitory computer-readable medium described herein may further include operations, features, means, or instructions for transmitting the fourth message that includes the indication of the one or more requested time slots in accordance with the one or more requested time slots conflicting with one or more time slots associated with an overlapping basic service set (OBSS) wireless AP.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIGS. 3 and 4 show example network deployment scenarios that support coordinated scheduling-based protocols for multi-hop traffic flows in a controller-based network.

FIGS. 5 and 6 show example process flows that support coordinated scheduling-based protocols for multi-hop traffic flows in a controller-based network.

FIG. 7 shows an example conflict resolution procedure that supports coordinated scheduling-based protocols for multi-hop traffic flows in a controller-based network.

FIG. 8 shows an example multi-hop transmission sequence that supports coordinated scheduling-based protocols for multi-hop traffic flows in a controller-based network.

FIGS. 9-11 show example communication sequences that support coordinated scheduling-based protocols for multi-hop traffic flows in a controller-based network.

FIG. 12 shows a block diagram of an example wireless communication device that supports coordinated scheduling-based protocols for multi-hop traffic flows in a controller-based network.

FIGS. 13-17 show flowcharts illustrating example processes performable by or at a first wireless access point (AP) or a network controller that support coordinated scheduling-based protocols for multi-hop traffic flows in a controller-based network.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, such as mesh networks, each of multiple access points (APs) within the network may operate in one or more of various modes in accordance with a role or placement of that AP within the network. For example, an AP within the network that is connected to a wired foundation of the network may operate in a root mode. In accordance with operating in the root mode, the AP may provide network access to one or more other APs along with one or more stations (STAs) associated with the AP. An AP operating in the root mode may be referred to herein as a root AP. Such other APs (for which network access is provided by the root AP) may operate in a repeater mode according to which an AP provides a wireless (multi-hop) link to the wired network. For example, in accordance with operating in the repeater mode, an AP may connect with one or more STAs as an AP and may connect with the root AP as a client. An AP operating in the repeater mode may be referred to herein as a repeater AP and may connect with the root AP as a backhaul STA (b-STA). In networks including both a root AP and one or more repeater APs, a traffic flow to or from a STA associated with a repeater AP may be associated with multiple hops including at least a first hop between the repeater AP and the STA, and a second hop between repeater AP and the root AP (or another repeater AP).

In some deployments, APs within a network may coordinate on one or more schedules of time slots (which an AP may use for communication) in accordance with a coordinated scheduling-based protocol. For example, if a first AP expects or plans to communicate a periodic traffic flow between the first AP and a STA associated with the first AP, the first AP may establish a first schedule of time slots for the periodic traffic and may coordinate the first schedule of time slots with at least a second AP. By coordinating the first schedule of time slots with the second AP, the second AP may establish a second schedule of time slots for its own in-basic service set (BSS) communication that avoids overlapping in time with the first schedule of time slots of the first AP. To protect a traffic flow in networks including a root AP and one or more repeater APs (or, generally, any two or more “hops”), multiple schedules of time slots may be expected, such as a first schedule of time slots for communication between a repeater AP and an associated STA, and a second schedule of time slots for communication between the repeater AP and the root AP. Some networks, however, may lack mechanisms according to which multiple schedules of time slots for a multi-hop (end-to-end) traffic flow can be established, suitably aligned, and coordinated. Thus, some networks may benefit from additional mechanisms according to which times slots for multi-hop traffic flows can be established and coordinated among multiple APs within the network.

Various aspects relate generally to a coordinated scheduling of multi-hop traffic flows within a network of multiple APs including a root AP and one or more repeater APs. Some aspects more specifically relate to a coordinated scheduling of time slots for multi-hop traffic flows across both fronthaul and backhaul links in controller-based networks. In some examples, an AP within the network may provide (such as transmit or propagate) information indicative of one or more established (and coordinated) schedules of time slots to a network controller and the network controller may use such information for conflict resolution between different schedules of time slots. For example, in accordance with the propagation of established (and coordinated) schedules of time slots to the network controller, the network controller may obtain a complete view of traffic patterns within the network (including both fronthaul and backhaul schedules for each multi-hop traffic flow) and may leverage such a complete view for conflict resolution and to maintain suitable alignments of time slots allocated for multi-hop traffic flows across multiple hops.

In some implementations, a first AP (such as a repeater AP) may establish and advertise a first schedule of time slots for a fronthaul communication of a traffic flow between the first AP and a STA associated with the first AP and may update the network controller on the established and advertised first schedule of time slots. The first AP may further transmit messaging associated with establishing a second schedule of time slots for a backhaul communication of the traffic flow between the first AP and a second AP (such as a root AP). Such messaging may include a transmission, to the second AP or to the network controller, of a request for the second schedule of time slots. The second AP or the network controller may establish the second schedule of time slots for the backhaul communication of the traffic flow in accordance with whether the first AP transmits the request to the second AP or the network controller.

Additionally, or alternatively, an AP within the network may rely on a configuration by the network controller of one or more coordinated schedules of time slots. For example, a first AP (such as a repeater AP) may transmit, to the network controller, a request for coordinated time slots for a multi-hop traffic flow between a second AP (such as a root AP) and a STA associated with the first AP. In accordance with receiving the request from the first AP, the network controller may configure a first schedule of time slots for a fronthaul communication of the traffic flow between the first AP and the STA and a second schedule of time slots for a backhaul communication of the traffic flow between the first AP and the second AP. For example, the network controller may transmit a first message to the first AP including information indicative of the first schedule of time slots and may transmit a second message to the second AP including information indicative of the second schedule of time slots. The network controller may coordinate the first and second schedules of time slots with other active schedules within the network to avoid a conflict between any two schedules. Further, in some implementations, the first AP and the second AP may advertise the first schedule of time slots and the second schedule of time slots, respectively, via broadcast signaling (to inform other devices of the coordinated schedules of time slots).

As described herein, time slots, including schedules of time slots, may be associated with a coordinated scheduling-based protocol according to which time slots associated with different traffic flows avoid conflicting with each other. For example, in accordance with the coordinated scheduling-based protocol, one or more first time slots associated with a first traffic flow may avoid conflicting with one or more second time slots associated with a second traffic flow. Additionally, or alternatively, time slots associated with (such as owned by) different wireless communication devices (such as different APs) may avoid conflicting with each other in accordance with the coordinated scheduling-based protocol. For example, one or more first time slots associated with a first AP may avoid conflicting with one or more second time slots associated with a second AP in accordance with the coordinated scheduling-based protocol. The coordinated scheduling-based protocol may be equivalently referred to as a coordinated calendar-based protocol, a service period-based subscription relying on a control-based protocol, or coordinated scheduling. Further, time slots associated with the coordinated scheduling-based protocol may be equivalently referred to as coordinated subscription-based time slots, windows, epochs, or regions. Examples of the coordinated scheduling-based protocol may include a coordinated restricted target wake time (C-rTWT) protocol or a coordinated listening interval (CLI) protocol. Thus, a time slot may refer generally to a restricted target wake time (rTWT) service period, a C-rTWT service period, or a CLI, among other examples. In some aspects, a coordinated time slot may refer more specifically to a C-rTWT service period or a CLI, among other examples.

Particular aspects of the subject matter described in this disclosure can be implemented to realize one or more of the following potential advantages. In some examples, by receiving updates on established and coordinated schedules of time slots, the network controller may maintain a complete and up-to-date view of traffic patterns within the network and may use such a view to efficiently resolve (potential) conflicts between two or more schedules of time slots. For example, the network controller may resolve a potential conflict between two schedules of time slots by considering a relative priority of the traffic flows associated with the two schedules and applying (and indicating) a time domain adjustment to the schedule associated with the relatively lower priority traffic flow. In such examples, the network controller may provide lower latency and greater reliability to the relatively higher priority traffic flow (while potentially still providing communication resources for the relatively lower priority traffic flow). Further, by enabling the network controller to configure a respective schedule of time slots for each of multiple hops associated with a traffic flow, the network controller may efficiently organize communications across the entire network, which may further support lower latency and greater reliability for various traffic flows, including multi-hop traffic flows. Moreover, by supporting lower latency and greater reliability, the described techniques may be further implemented to realize greater spectral efficiency, higher data rates, greater network throughput, improved user experience, and greater network capacity, among other benefits.

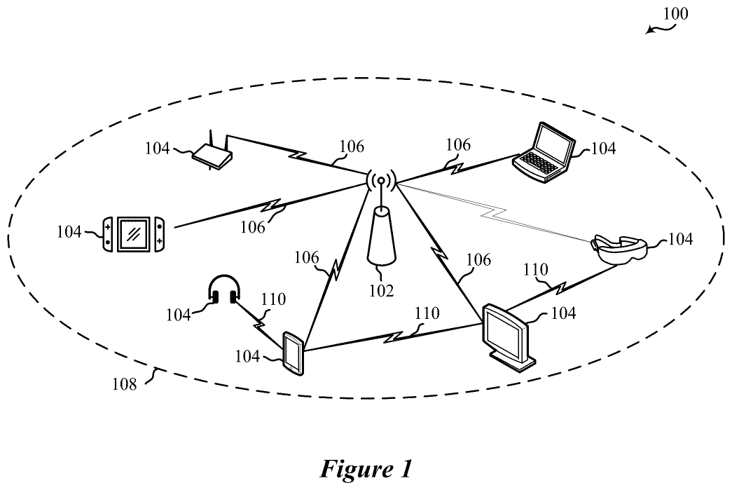

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any quantity of wireless STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent BSS (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure BSS, which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a transmission opportunity (TXOP) on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

In some wireless communication networks, such as the wireless communication network 100, a root AP 102 may provide network access to one or more repeater APs 102. In some aspects, the root AP 102 may communicate with a network controller, which may be physically collocated or non-collocated with the root AP 102. In accordance with some example implementations, one or more APs 102 may communicate (such as transmit or receive, or both) messaging associated with establishing schedules of time slots within which the one or more APs 102 may communicate a traffic flow across multiple hops. In some examples, the multiple hops may include a first hop between the root AP 102 and a repeater AP 102 and a second hop between the repeater AP 102 and a STA 104 associated with the repeater AP 102. In some other examples, the multiple hops may include a first hop between the root AP 102 and a first repeater AP 102, a second hop between the first repeater AP 102 and a second repeater AP 102, and a third hop between the second repeater AP 102 and a STA 104 associated with the second repeater AP 102. Generally, a multi-hop traffic flow may flow across any quantity of APs 102, including any quantity of repeater APs 102, between a root AP 102 and a STA 104. For example, the described techniques may apply to a mesh layout in a star topology (in which each device is connected to a central controller) or a daisy topology (in which devices are connected in a series).

In some implementations, the network controller may maintain up-to-date information pertaining to active schedules of time slots within the network and may use such information to resolve potential conflicts between two or more schedules of time slots or to mediate the establishment of new schedules of time slots within the network. The network controller may maintain such information and mediate the establishment of new schedules within the network in accordance with communicating (such as transmitting or receiving, or both) one or more messages with one or more APs 102.

For example, an AP 102 may update the network controller each time the AP 102 establishes and coordinates a new schedule of time slots. In such examples, the AP 102 may transmit information indicative of the new schedule of time slots to the network controller. In some implementations (such as implementations in which the traffic flow is classified by the AP 102), the AP 102 also may provide timing information associated with the corresponding traffic flow to the network controller. Such timing information may include an indication of one or more service level agreement (SLA) parameters associated with the traffic flow or an indication of a stream classification service (SCS) associated with the traffic flow, or both. In some other implementations (such as implementations in which the traffic flow is classified by a root AP 102 or the network controller), the AP 102 may refrain from providing the timing information associated with the corresponding traffic flow to the network controller.

Additionally, or alternatively, an AP 102 may transmit a request to the network controller for a schedule of time slots for a traffic flow. In some examples, the request may be a request for multiple schedules of time slots (such as for a respective schedule of time slots for each of multiple hops associated with the traffic flow). In some implementations (such as implementations in which the traffic flow is classified by the AP 102), the request by the AP 102 may include timing information associated with the traffic flow. Such timing information may include an indication of one or more SLA parameters associated with the traffic flow or an indication of an SCS associated with the traffic flow, or both. In some other implementations (such as implementations in which the traffic flow is classified by a root AP 102 or the network controller), the request by the AP 102 may exclude timing information associated with the traffic flow. The network controller may configure one or more schedules of time slots at one or more APs 102 in accordance with the request (and in accordance with the timing information associated with the traffic flow).

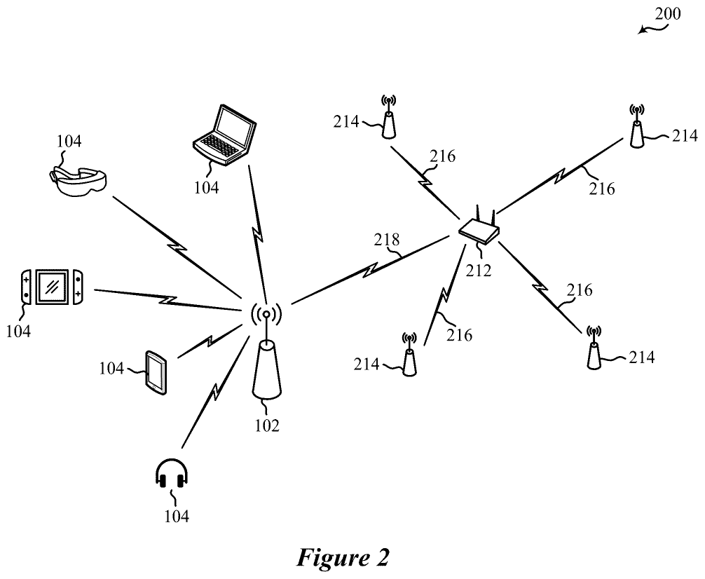

FIG. 2 shows a pictorial diagram of another example wireless communication network 200. According to some aspects, the wireless communication network 200 can be an example of a mesh network, an IoT network, or a sensor network in accordance with one or more of the IEEE 802.11 family of wireless communication protocol standards (including the 802.11ah amendment). The wireless communication network 200 may include multiple wireless communication devices 214, which in some implementations may include APs 102, STAs 104, or both. The wireless communication devices 214 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (such as audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a WLAN or a wireless (such as cellular) wide area network (WWAN), which may, in turn, provide access to external networks including the Internet. For example, the intermediate device 212 may associate and communicate, over a Wi-Fi link 218, with an AP 102 of a wireless communication network 200, which also may serve various STAs 104. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QOS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some wireless communication networks, such as the wireless communication network 200, a root AP 102 may provide network access to one or more repeater APs 102. In some aspects, the root AP 102 may communicate with a network controller, which may be physically collocated or non-collocated with the root AP 102. In accordance with some example implementations, the network controller may maintain up-to-date information pertaining to active schedules of time slots within the network for conflict resolution or to mediate the establishment of new schedules of time slots within the network, or both.

As described herein, a network controller, which may be equivalently referred to as a central controller, may be a device, entity, role, cloud-based or functionality associated with managing or controlling signaling within a wireless communication network (such as the wireless communication network 200). The network controller may be a physical device or may be a role or functionality assumed by an AP 102 within the wireless communication network. In examples in which the network controller is a separate physical device, the network controller may communicate with one or more APs 102 within the network via wired signaling or wireless signaling, or any combination thereof. In examples in which the network controller is a role or functionality assumed by an AP 102, a root AP 102 or any other AP 102 within the network may assume the role or functionality of network controller.

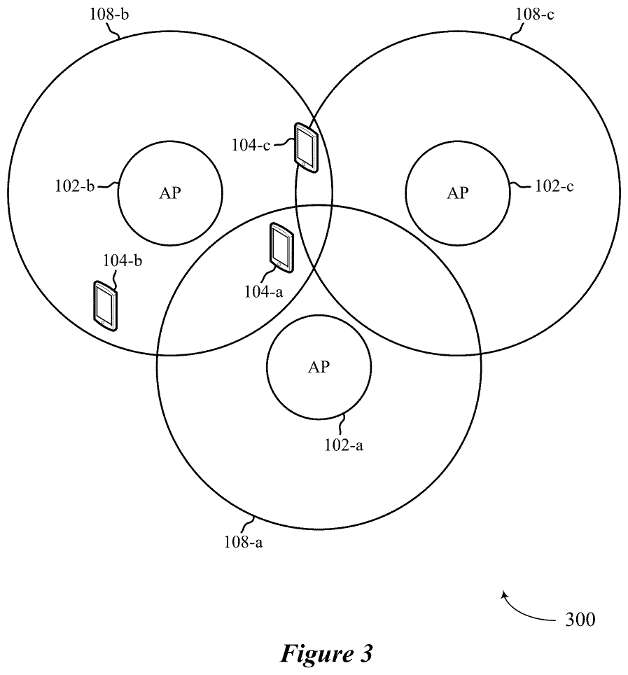

FIG. 3 shows an example network deployment scenario 300 that supports coordinated scheduling-based protocols for multi-hop traffic flows in a controller-based network. The network deployment scenario 300 may implement or be implemented to realize one or more aspects of the wireless communication network 100 or the wireless communication network 200. For example, the network deployment scenario 300 illustrates a network of APs 102 including an AP 102-a, an AP 102-b, and an AP 102-c associated with a coverage area 108-a, a coverage area 108-b, and a coverage area 108-c, respectively. The AP 102-a, the AP 102-b, and the AP 102-c may each be an example of an AP 102 as illustrated by and described with reference to FIGS. 1 and 2.

Each of the APs 102 of the network deployment scenario 300 (such as each of the AP 102-a, the AP 102-b, and the AP 102-c) may communicate with (such as transmit to or receive from, or both) one or more STAs 104. For example, the AP 102-a may communicate with a STA 104-a, the AP 102-b may communicate with a STA 104-b, and the AP 102-c may communicate with a STA 104-c. The STA 104-a, the STA 104-b, and the STA 104-c may be examples of STAs 104 as illustrated by and described with reference to FIGS. 1 and 2. As used herein, an AP 102 may generally refer to any one or more of the AP 102-a, the AP 102-b, and the AP 102-c and a STA 104 may generally refer to any one or more of the STA 104-a, the STA 104-b, and the STA 104-c.

In some examples, one or more of the various wireless communication devices of the network deployment scenario 300 may employ, use, configure, or otherwise communicate in accordance with a coordinated scheduling-based protocol. The coordinated scheduling-based protocol may be associated with a calendar-based schedule of communications throughout the network deployment scenario 300 such that, for example, potentially interfering communications are scheduled for non-overlapping time slots. Additionally, or alternatively, the coordinated scheduling-based protocol may be associated with a calendar-based schedule of communications throughout the network deployment scenario 300 such that, for example, communications associated with a given traffic flow are aligned end-to-end to support low-latency performance (such as low-latency communication) across multiple hops. In any of such examples, the coordinated scheduling-based protocol may be associated with coordinated AP operation. For example, the AP 102-a, the AP 102-b, and the AP 102-c may use, coordinate, collaborate, negotiate, or rely on a same coordinated scheduling-based protocol (such as a same calendar or a same schedule of communications) to avoid a time domain overlapping of potentially interfering communications or to schedule an end-to-end traffic flow across multiple hops, or both. Potentially interfering communications may include communications to or from devices that are at locations within multiple overlapping coverage areas.

In other words, a set of APs 102 may coordinate in accordance with the coordinated scheduling-based protocol to avoid interference amongst themselves by performing scheduled access to a wireless medium linearly across a time axis. In accordance with the coordinated scheduling-based protocol (such as a restricted target wake time (rTWT) protocol, a C-rTWT protocol, or a CLI protocol), each AP 102 and STA 104 may terminate a TXOP (and a transmission) before a start of a time slot (such as a service period) belonging to another member of the coordinated scheduling-based protocol (such as another AP 102 or STA 104). Further, in accordance with the coordinated scheduling-based protocol, an AP 102 may operate as or in the role of a coordinating AP 102 or a coordinated AP 102 across different coordinated schedules. For example, an AP 102 may coordinate (such as transmit information indicative of, such as advertise) a first schedule of time slots and may be informed of (such as receive information indicative of, such as via an advertisement by another AP 102) a second schedule of time slots. In such examples, the AP 102 may be a coordinating AP 102 with respect to the first schedule of time slots and may be a coordinated AP 102 with respect to the second schedule of time slots.

Additionally, in some implementations, a controller (such as a central or network controller) may mediate, negotiate, coordinate, configure, or set coordinated schedules across a coordinated AP set (such as a set of APs 102 including, for example, the AP 102-a, the AP 102-b, and the AP 102-c). For example, a network controller may communicate with the AP 102-a, which may function or operate as a root AP 102, and the network controller may configure coordinated schedules of time slots for communications within the network deployment scenario 300 or may mediate between any conflicting (such as overlapping in time) schedules of time slots within the network deployment scenario 300, or both. In accordance with some example implementations, one or more APs 102 of the network deployment scenario 300 may provide information indicative of or otherwise associated with one or more schedules of time slots to the network controller. The network controller may store and use such information to grant or configure a new coordinated schedule of time slots, to update or re-configure a previously-established coordinated schedule of time slots, or to mediate between two or more schedules of time slots that at least partially overlap in time, among other examples.

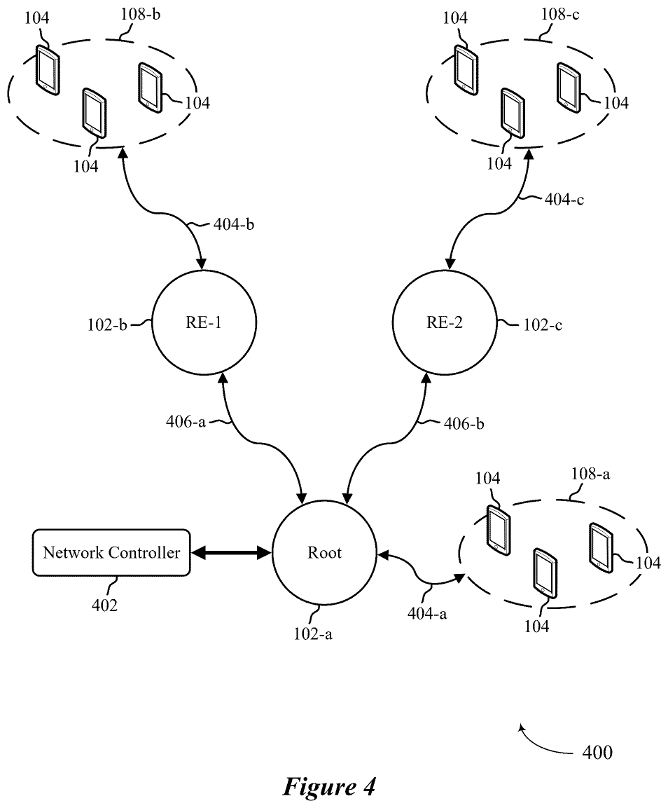

FIG. 4 shows an example network deployment scenario 400 that supports coordinated scheduling-based protocols for multi-hop traffic flows in a controller-based network. The network deployment scenario 400 may implement or be implemented to realize one or more aspects of the wireless communication network 100, the wireless communication network 200, or the network deployment scenario 300. For example, the network deployment scenario 400 illustrates a network of APs 102 including an AP 102-a, an AP 102-b, and an AP 102-c associated with a coverage area 108-a, a coverage area 108-b, and a coverage area 108-c, respectively. In some aspects, the AP 102-a may be an example of a root AP 102 in communication with a network controller 402. In such aspects, the AP 102-b and the AP 102-c may be examples of repeater APs 102 (such as a repeater AP “RE-1” and a repeater AP “RE-2”). In accordance with being repeater APs 102, the AP 102-b and the AP 102-c may, in part, function or operate as relay nodes between an associated STA 104 and the AP 102-a (which may provide network access).

The AP 102-a, the AP 102-b, and the AP 102-c of the network deployment scenario 400 may be examples of the AP 102-a, the AP 102-b, and the AP 102-c, respectively, of the network deployment scenario 300. Further, the coverage area 108-a, the coverage area 108-b, and the coverage area 108-c of the network deployment scenario 400 may be examples of the coverage area 108-a, the coverage area 108-b, and the coverage area 108-c, respectively, of the network deployment scenario 300. The AP 102-a may communicate with one or more STAs 104 within the coverage area 108-a via one or more communication links 404-a, the AP 102-b may communicate with one or more STAs 104 within the coverage area 108-b via one or more communication links 404-b, and the AP 102-c may communicate with one or more STAs 104 within the coverage area 108-c via one or more communication links 404-c. In some scenarios, the coverage area 108-a, the coverage area 108-b, and the coverage area 108-c may be at least partially overlapping.

The AP 102-a may communicate with the network controller 402 via a wired connection or a wireless connection, or both. The AP 102-a and the network controller 402 may be part of a same physical device (such as collocated) or may be physically separate devices (such as non-collocated). The network controller 402 may control, organize, or schedule at least a portion of communications within the network such that, for example, the network deployment scenario 400 may be associated with or otherwise referred to as a controller-based network. In some implementations, the network controller 402 may support a coordinated scheduling-based protocol according to which the network controller 402 may provide a calendar (such as a schedule) of communications (such as a calendar design associated with the coordinated scheduling-based protocol). In accordance with the calendar of communications, the network controller 402 may allocate time slots (such as one or more schedules of time slots) across the AP nodes (such as the AP 102-a, the AP 102-b, and the AP 102-c) in various types of controller-based networks (including, for example, mesh controller-based networks).

To support such a coordinated scheduling-based protocol at the network controller 402, one or more of the AP 102-a, the AP 102-b, and the AP 102-c may transmit information indicative of one or more established schedules of time slots or of one or more requested schedules of time slots to the network controller 402. For example, the AP 102-b may transmit, to the network controller 402, information indicative of a first schedule of time slots that the AP 102-b intends or requests to use for communication with a STA 104 associated with the AP 102-b. The AP 102-b may indirectly transmit such information to the network controller 402 via a communication link 406-a (such as a backhaul link, which may be associated with a wired connection or a wireless connection, or both) between the AP 102-b and the AP 102-a or may directly transmit such information to the network controller 402 (such as via 1905.1 signaling). Additionally, or alternatively, the AP 102-c may transmit, to the network controller 402, information indicative of a second schedule of time slots that the AP 102-c intends or requests to use for communication with a STA 104 associated with the AP 102-c. The AP 102-c may indirectly transmit such information to the network controller 402 via a communication link 406-b (such as a backhaul link, which may be associated with a wired connection or a wireless connection, or both) between the AP 102-c and the AP 102-a or may directly transmit such information to the network controller 402 (such as via 1905.1 signaling). The network controller 402 may use the received information to confirm, deny, configure, coordinate, or adjust one or both of the first schedule of time slots or the second schedule of time slots.

In some deployments, the network controller 402 may provide or otherwise be associated with a single point of entry or exit to the network, which may enable the network controller 402 to coordinate incoming and outgoing flows (such as traffic flows or data flows) across the nodes (such as across the various wireless communication devices within the network deployment scenario 400). In accordance with the network controller 402 providing the single point of entry or exit to the wireless communication network and in accordance with the coordinated scheduling-based protocol at the network controller 402, the network controller 402 may align scheduled time slots across the nodes of the network deployment scenario 400 such that any potentially-interfering transmissions are aligned across the time axis (in a non-overlapping manner).

The communications for which the network controller 402 may configure or establish one or more scheduled (and coordinated) time slots may include communications between an AP 102 and an associated STA 104 or between two APs 102 (such as between a b-STA functionality of a first AP 102 and an AP functionality of a second AP 102 in a mesh network). In other words, any communication through or via the AP 102-b or the AP 102-c may be a candidate for protection by the network controller 402 via a coordinated schedule of time slots. Further, the communications for which the network controller 402 may configure or establish one or more scheduled (and coordinated) time slots may include periodic traffic, such as periodic ultra-low-latency traffic, flowing through the AP 102-a (the root AP 102) across one of the b-STAs or across any other nodes (such as STAs 104) of the network deployment scenario 400. For example, if two or more periodic traffic flows are associated with multiple hops and are potentially interfering with each other, the network controller 402 may coordinate the scheduling of time slots for the periodic traffic flows across the multiple hops (such that the scheduled time slots are non-overlapping with each other in time across the multiple hops). In some implementations, the network controller 402 may allocate time slots for periodic traffic flows across multiple hops in a controller-based network in accordance with end-to-end SLA parameters or priority information associated with the periodic traffic flows throughout the network.

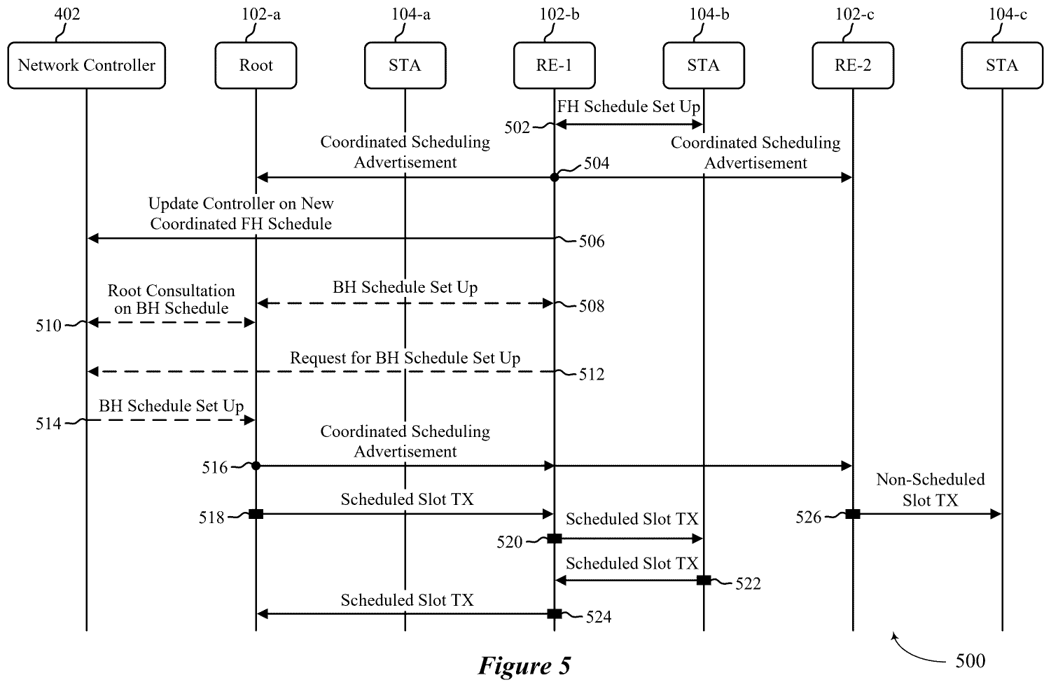

FIG. 5 shows an example process flow 500 that supports coordinated scheduling-based protocols for multi-hop traffic flows in a controller-based network. The process flow 500 may implement or be implemented to realize one or more aspects of the wireless communication network 100, the wireless communication network 200, the network deployment scenario 300, or the network deployment scenario 400. For example, the process flow 500 illustrates communication between or involving a network controller 402, an AP 102-a, a STA 104-a, an AP 102-b, a STA 104-b, an AP 102-c, and a STA 104-c. The network controller 402 of FIG. 5 may be an example of the network controller 402 as illustrated by and described with reference to FIG. 4. The AP 102-a, the AP 102-b, and the AP 102-c of FIG. 5 may be examples of the AP 102-a, the AP 102-b, and the AP 102-c, respectively, as illustrated by and described with reference to FIGS. 3 and 4. The STA 104-a, the STA 104-b, and the STA 104-c may be examples of the STA 104-a, the STA 104-b, and the STA 104-c, respectively, as illustrated by and described with reference to FIG. 3.

Alternative examples of the following may be implemented. Some steps are performed in a different order than described or are not performed at all. In some implementations, steps may include additional features not mentioned below, or further steps may be added. Further, although example devices are shown performing the operations of the process flow 500, some aspects of some operations also may be performed by one or more other wireless communication devices without exceeding the scope of the present disclosure.

At 502, the AP 102-b and the STA 104-b (a fronthaul client device of the AP 102-b) may establish or set up a fronthaul (illustrated as “FH” in the example of the process flow 500) schedule of time slots associated with a communication of a traffic flow, such as a periodic SLA flow, between the AP 102-b and the STA 104-b. In some aspects, the STA 104-b may establish or set up a traffic flow with the AP 102-b by transmitting a frame (such as an SCS frame) to the AP 102-b. In other words, the STA 104-b may transmit, to the AP 102-b, a frame indicating an establishment, start, or beginning of a traffic flow to or from the STA 104-b. The traffic flow may be classified as an SLA flow at the network controller 402, the AP 102-a, the AP 102-b, or the STA 104-b.

The AP 102-b may establish or set up a corresponding schedule of time slots to serve the traffic flow in accordance with the timing specified by the frame. For example, the frame transmitted by the STA 104-b may indicate timing information (such as a service interval or a start time, among other examples) associated with the traffic flow and the AP 102-b may establish or set up a schedule of time slots in accordance with the timing information. For example, the fronthaul schedule set up at 502 may be associated with or referred to as a fronthaul SCS+rTWT set up. In some aspects, the traffic flow (such as the fronthaul SLA flow) may be an end-to-end traffic flow flowing through one or both of the network controller 402 and the AP 102-a, a b-STA of the AP 102-b, and the STA 104-b. In other words, the traffic flow may be associated with multiple hops. Accordingly, one or more of various wireless communication devices may protect the (periodic and low-latency) traffic flow from end-to-end (such as all the way through the network, including across the multiple hops).

At 504, the AP 102-b may establish or create a matching coordinated schedule of time slots (such as a coordinated schedule of time slots that matches, or is the same as, the schedule of time slots established as part of the fronthaul schedule established at 502). The AP 102-b may establish or create the matching coordinated schedule of time slots (such as one or more C-rTWT service periods) in accordance with performing a coordinated scheduling advertisement, such as by transmitting information indicative of the schedule of time slots via advertising broadcast signaling. The AP 102-b may transmit such information via one or more of various frame types, including a management frame (such as a beacon frame), an announcement frame, a trigger frame, or a data frame. The AP 102-a and the AP 102-c may receive the information indicative of the coordinated schedule of time slots in accordance with the advertising broadcast signaling from the AP 102-b and each of the AP 102-a and the AP 102-c may propagate (such as transmit or relay) the information indicative of the coordinated schedule of time slots to their respective BSSs (both in fronthaul and backhaul). In this manner, the AP 102-a and the AP 102-c, along with any client devices of the AP 102-a and the AP 102-c (such as the STA 104-a and the STA 104-c), may end or terminate any ongoing TXOP or transmissions before or at a start of a time slot of the coordinated schedule of time slots advertised by the AP 102-b. In other words, the AP 102-a and the AP 102-c, as well as their in-BSS STAs 104, may respect the coordinated schedule of time slots advertised by the AP 102-b. In-BSS STAs 104 of the AP 102-b also may respect the coordinated fronthaul schedule of time slots advertised by the AP 102-b.

At 506, the AP 102-b may update the network controller 402 on the new coordinated schedule of time slots. For example, the AP 102-b may send a message, such as a 1905 or a 1905.1 message, to provide the network controller 402 with information indicative of the coordinated schedule of time slots established (such as created or allocated) by the AP 102-b. In some implementations, the network controller 402 may store the information indicative of the coordinated schedule of time slots and may use such information for conflict resolution (if, for example, two or more established or requested schedules of time slots conflict with each other). In some implementations, the information that the AP 102-b transmits to the network controller 402 may include timing information associated with the traffic flow (such as a service interval or a start time, among other example SLA parameters) and one or more other parameters, such as an indication of an SCS or priority associated with the traffic flow. In some other implementations, the information that the AP 102-b transmits to the network controller 402 may exclude timing information associated with the traffic flow (if, for example, the traffic flow is classified as an SLA flow at the network controller 402 or the AP 102-a).

At 508, in some implementations, the AP 102-a and the AP 102-b may establish or set up a backhaul (illustrated as “BH” in the example of the process flow 500) schedule of time slots associated with a communication of the traffic flow between the AP 102-a and the AP 102-b. In such implementations, a b-STA of the AP 102-b may transmit, to the AP 102-a, a message (such as a direct SCS frame) that includes information indicative of the schedule of time slots established for the fronthaul communication of the traffic flow between the AP 102-b and the STA 104-b. For example, the b-STA of the AP 102-b may transmit the message (such as the direct SCS frame) to align or provide the fronthaul SCS (such as the fronthaul schedule of time slots) to the AP 102-a. For example, the backhaul schedule set up at 508 may be associated with or referred to as a backhaul SCS+rTWT set up. The AP 102-a may parse the information provided by the AP 102-b to ascertain, determine, select, or identify the schedule of time slots established for the fronthaul communication between the AP 102-b and the STA 104-b. The AP 102-a may establish or set up a matching or aligned schedule of time slots with the b-STA of the AP 102-b in accordance with receiving (and parsing) the information indicative of the fronthaul schedule of time slots.

In other words, the AP 102-a may establish a backhaul schedule of time slots for communication with the b-STA of the AP 102-b such that one or more time slots of the backhaul schedule of time slots are aligned with one or more time slots of the fronthaul schedule of time slots. Such an alignment may include time slots that avoid overlapping in time with each other. In some implementations, the AP 102-a may establish a backhaul schedule of time slots for communication with the b-STA of the AP 102-b such that one or more time slots of the backhaul schedule of time slots are consecutive in time (such as immediately consecutive in time) with one or more time slots of the fronthaul schedule of time slots.

At 510, in some implementations, the AP 102-a may consult the network controller 402 for a suitable schedule of time slots for the backhaul communication between the AP 102-a and the AP 102-b. In some examples, the AP 102-a may consult the network controller 402 to resolve any conflicts that a requested schedule of time slots may have with a schedule of time slots of an OBSS AP 102. For example, prior to establishing the backhaul schedule of time slots for the traffic flow, the AP 102-a may request the network controller 402 to provide an indication of a suitable schedule of time slots for the backhaul communication or to provide information that the AP 102-a may use to ascertain, determine, select, or identify a suitable schedule of time slots for the backhaul communication. In such examples, the AP 102-a may transmit a message to the network controller 402 requesting information indicative of a suitable schedule of time slots for the backhaul communication and may receive, from the network controller 402, a message providing the requested information.

The network controller 402 may provide an indication of a suitable schedule of time slots for the backhaul communication or information that the AP 102-a may use to ascertain, determine, select, or identify a suitable schedule of time slots for the backhaul communication in accordance with information indicative of one or more active coordinated schedules of time slots stored at the network controller 402. For example, a suitable schedule of time slots for the backhaul communication as provided by the network controller 402 may avoid overlapping with other active coordinated schedules of time slots (at other APs 102 within the network). Additionally, in some implementations, a suitable schedule of time slots for the backhaul communication as provided by the network controller 402 may include one or more time slots that are consecutive in time (such as immediately consecutive in time and non-overlapping) with one or more time slots of the fronthaul schedule of time slots.

At 512, in some implementations, the AP 102-b may transmit, to the network controller 402, a request for the network controller 402 to establish or set up a backhaul schedule of time slots for the communication of the traffic flow between the AP 102-a and the b-STA of the AP 102-b. In such implementations, the AP 102-b may transmit a message to the network controller 402 that indicates one or more of the request for the establishment of the backhaul schedule of time slots, the established fronthaul schedule of time slots, or one or more SLA parameters associated with the traffic flow. For example, the AP 102-b may transmit the request for the network controller 402 to establish the backhaul schedule of time slots by performing a 1905 or 1905.1 forwarding, to the network controller 402, of the SCS frame received from the STA 104-b at 502 along with information indicative of the fronthaul schedule of time slots. For example, the request for the backhaul scheduling set up sent by the AP 102-b at 512 may be associated with or understood as a 1905.1 SCS+rTWT forwarding from the AP 102-b to the network controller 402. In some aspects, the AP 102-b may transmit the request at 512 as an alternative to the establishment of the backhaul schedule of time slots at 508 and the optional consultation of the network controller 402 by the AP 102-a at 510.

At 514, in implementations in which the AP 102-b requests the network controller 402 to establish the backhaul schedule of time slots, the network controller 402 may configure and transmit information indicative of the backhaul schedule of time slots for the communication between the AP 102-a and the b-STA of the AP 102-b. In some examples, the network controller 402 may indicate the backhaul schedule of time slots via a frame or message associated with a configuration or indication, at or to the AP 102-a, of both the SLA/SCS associated with the traffic flow and the backhaul schedule of time slots. For example, the information indicative of the backhaul schedule of time slots may include an indication of the backhaul schedule of time slots and an indication of one or more SLA parameters or an SCS associated with the traffic flow. In some aspects, the backhaul schedule set up at 514 may be associated with or understood as a 1905.1 SCS+C-rTWT configuration to the AP 102-a.

The network controller 402 may provide an indication of the backhaul schedule of time slots in accordance with information indicative of one or more active coordinated schedules of time slots stored at the network controller 402. For example, the backhaul schedule of time slots as provided by the network controller 402 may avoid overlapping with other active coordinated schedules of time slots. Additionally, in some implementations, the backhaul schedule of time slots as provided by the network controller 402 may include one or more time slots that are consecutive in time (such as immediately consecutive in time and non-overlapping) with one or more time slots of the fronthaul schedule of time slots. In some implementations, the network controller 402 may configure the backhaul schedule of time slots by resolving any conflicts between active/requested schedules of time slots across the various nodes within the network. In other words, the network controller 402 may configure the backhaul schedule of time slots in the AP 102-a (the root AP 102), which the AP 102-a may propagate to the AP 102-b and the AP 102-c, by resolving any conflict that may be present with another (active) schedule of time slots of a self or OBSS node. In some aspects, the network controller 402 may provide the configuration of the backhaul schedule of time slots to the AP 102-a at 514 as an alternative to the establishment of the backhaul schedule of time slots at 508 and the optional consultation of the network controller 402 by the AP 102-a at 510.

At 516, the AP 102-a may establish or set up a coordinated schedule of time slots (for the backhaul communication) by performing a coordinated scheduling advertisement of the backhaul schedule of time slots. For example, the AP 102-a may transmit information indicative of the backhaul schedule of time slots via advertising broadcast signaling. The AP 102-a may transmit such information via one or more of various frame types, including a management frame (such as a beacon frame), an announcement frame, a trigger frame, or a data frame. The AP 102-b and the AP 102-c may receive the information indicative of the coordinated schedule of time slots for the backhaul communication in accordance with the advertising broadcast signaling from the AP 102-a and each of the AP 102-b and the AP 102-c may propagate (such as transmit or relay) the information indicative of the coordinated schedule of time slots for the backhaul communication to their respective BSSs (both in fronthaul and backhaul). In this manner, the AP 102-b and the AP 102-c, along with any client devices of the AP 102-b and the AP 102-c (such as the STA 104-b and the STA 104-c), may end or terminate any ongoing TXOP or transmissions before or at a start of a time slot of the coordinated schedule of time slots advertised by the AP 102-a. In other words, the AP 102-b and the AP 102-c, as well as their in-BSS STAs 104, may respect the coordinated schedule of time slots advertised by the AP 102-a. In yet other words, the AP 102-a (the root AP 102) may set up a coordinated schedule of time slots with the AP 102-b and the AP 102-c such that the transmissions between the AP 102-a and the b-STA of the AP 102-b are non-overlapping with (at least) the fronthaul transmissions between the AP 102-b and the STA 104-b. In-BSS STAs 104 of the AP 102-a also may respect the coordinated backhaul schedule of time slots advertised by the AP 102-a.

In accordance with such signaling mechanisms between the AP 102-a, the AP 102-b, the STA 104-b, and the network controller 402, such wireless communication devices may establish or create an end-to-end schedule of time slots (with such an end-to-end schedule of time slots being associated with, for example, a combination of the fronthaul schedule of time slots and the backhaul schedule of time slots) to protect chain transmissions associated with the end-to-end SLA flow between the AP 102-a and the STA 104-b. Further, a wireless communication device may group two or more SLA flows within a single time slot (or within a single schedule of time slots) if arrival patterns and periodicities of the two or more SLA flows (approximately) match each other. Additionally, or alternatively, a wireless communication device may decide to serve an SLA flow without the protection of a coordinated schedule of time slots or to reject an SCS request (for an SLA flow) if one or more conditions are satisfied. Such conditions may include, for example, if a corresponding schedule of time slots conflicts (or would conflict) with an incumbent coordinated schedule of time slots (of self or an OBSS) or if time slot allocation along the time axis becomes too granular (such as if time slots become less than a threshold duration or expect more than a threshold amount of precision across the network), which might make it difficult for the network to synchronize through the fronthaul and backhaul of multiple nodes.

At 518, in accordance with the establishment of the backhaul schedule of time slots and the fronthaul schedule of time slots for the end-to-end SLA flow, the AP 102-a may perform a first scheduled slot transmission (illustrated as “TX” in the example of the process flow 500). Such a first scheduled slot transmission may refer to or include a transmission of a data frame, a trigger frame, an announcement frame, or a TXOP sharing (TXS) frame, among other examples, within a first time slot of the backhaul schedule of time slots.

At 520, and in association with receiving the first scheduled slot transmission at 518, the AP 102-b may perform a second scheduled slot transmission. Such a second scheduled slot transmission may refer to or include a transmission of a data frame, a trigger frame, or a TXS frame within a first time slot of the fronthaul schedule of time slots. In some implementations, the first time slot of the backhaul schedule of time slots and the first time slot of the fronthaul schedule of time slots may be consecutive in time. Alternatively, such a second scheduled slot transmission may refer to or include a transmission of a data frame, a trigger frame, or a TXS frame within the first time slot of the backhaul schedule of time slots (in examples in which the AP 102-a shares a portion of the first time slot of the backhaul schedule of time slots with the AP 102-b).

At 522, and in association with receiving the second scheduled slot transmission at 520, the STA 104-b may perform a third scheduled slot transmission. Such a third scheduled slot transmission may refer to or include a transmission of a data frame or a TXOP return frame within a second time slot of the fronthaul schedule of time slots. Alternatively, such a third scheduled slot transmission may refer to or include a transmission of a data frame or a TXOP return frame within the first time slot of the fronthaul schedule of time slots (in examples in which the AP 102-b shares a portion of the first time slot of the fronthaul schedule of time slots with the STA 104-b).

At 524, and in association with receiving the third scheduled slot transmission at 522, the AP 102-b may perform a fourth scheduled slot transmission. Such a fourth scheduled slot transmission may refer to or include a transmission of a data frame or a TXOP return frame within a second time slot of the backhaul schedule of time slots. In some implementations, the second time slot of the backhaul schedule of time slots and the second time slot of the fronthaul schedule of time slots may be consecutive in time. Alternatively, such a fourth scheduled slot transmission may refer to or include a transmission of a data frame or a TXOP return frame within the second time slot of the fronthaul schedule of time slots (in examples in which the STA 104-b shares a portion of the second time slot of the fronthaul schedule of time slots with the AP 102-b).

At 526, the AP 102-c may, in some implementations, perform a non-scheduled slot transmission. For example, if the AP 102-c ascertains, measures, or otherwise determines that the non-scheduled slot transmission will not interfere with the communication of the end-to-end SLA flow between the AP 102-a and the STA 104-b, the AP 102-c may perform the non-scheduled slot transmission to the STA 104-c associated with the AP 102-c.

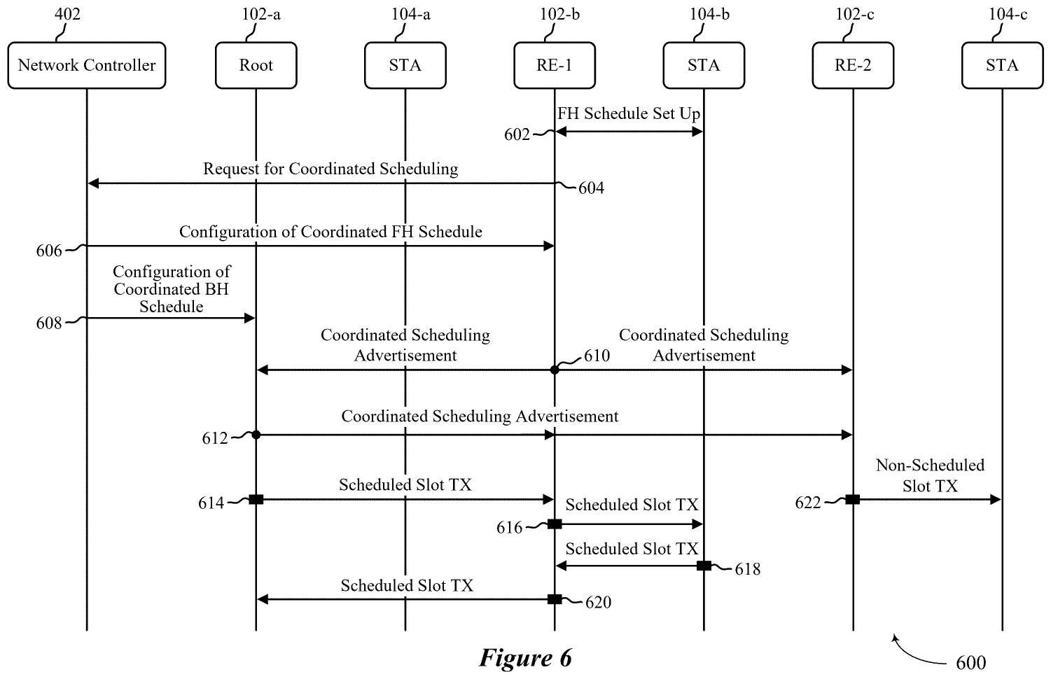

FIG. 6 shows an example process flow 600 that supports coordinated scheduling-based protocols for multi-hop traffic flows in a controller-based network. The process flow 600 may implement or be implemented to realize one or more aspects of the wireless communication network 100, the wireless communication network 200, the network deployment scenario 300, or the network deployment scenario 400. For example, the process flow 600 illustrates communication between or involving a network controller 402, an AP 102-a, a STA 104-a, an AP 102-b, a STA 104-b, an AP 102-c, and a STA 104-c. The network controller 402 of FIG. 5 may be an example of the network controller 402 as illustrated by and described with reference to FIG. 4. The AP 102-a, the AP 102-b, and the AP 102-c of FIG. 5 may be examples of the AP 102-a, the AP 102-b, and the AP 102-c, respectively, as illustrated by and described with reference to FIGS. 3 and 4. The STA 104-a, the STA 104-b, and the STA 104-c may be examples of the STA 104-a, the STA 104-b, and the STA 104-c, respectively, as illustrated by and described with reference to FIG. 3.

Alternative examples of the following may be implemented. Some steps are performed in a different order than described or are not performed at all. In some implementations, steps may include additional features not mentioned below, or further steps may be added. Further, although example devices are shown performing the operations of the process flow 600, some aspects of some operations also may be performed by one or more other wireless communication devices without exceeding the scope of the present disclosure.

At 602, the AP 102-b and the STA 104-b (a fronthaul client device of the AP 102-b) may establish or set up a fronthaul (illustrated as “FH” in the example of the process flow 600) schedule of time slots associated with a communication of a traffic flow, such as a periodic SLA flow, between the AP 102-b and the STA 104-b. In some aspects, the STA 104-b may establish or set up the traffic flow by transmitting a frame (such as an SCS frame) to the AP 102-b. In other words, the STA 104-b may transmit, to the AP 102-b, a frame indicating an establishment, start, or beginning of a traffic flow to or from the STA 104-b. The traffic flow may be classified as an SLA flow at the network controller 402, the AP 102-a, the AP 102-b, or the STA 104-b.

The AP 102-b may, in some implementations, establish or set up a corresponding schedule of time slots to serve the traffic flow in accordance with the timing specified by the frame. For example, the frame transmitted by the STA 104-b may indicate timing information (such as a service interval or a start time, among other examples) associated with the traffic flow and the AP 102-b may establish or set up a fronthaul schedule of time slots in accordance with the timing information. In such implementations, the fronthaul schedule set up at 602 may be associated with or referred to as a fronthaul SCS+rTWT set up. In some other implementations, the AP 102-b may refrain from establishing or setting up a corresponding schedule of time slots to serve the SLA flow and, instead, may rely on the network controller 402 to provide a fronthaul schedule of time slots.

The AP 102-b may establish a fronthaul schedule of time slots to serve the traffic flow in accordance with a satisfaction of one or more conditions. For example, the AP 102-b may establish the fronthaul schedule of time slots to serve the SLA flow in examples in which the SLA flow is an initial flow within the network, in examples in which there are less than a threshold quantity of SLA flows within the network, or in examples in which the AP 102-b has at least a threshold confidence level that the fronthaul schedule of time slots will avoid conflicting with one or more incumbent schedules of time slots. Otherwise, the AP 102-b may rely on the network controller 402 to provide the fronthaul schedule of time slots to serve the traffic flow. The traffic flow (such as the fronthaul SLA flow) may be an end-to-end flow flowing through one or both of the network controller 402 and the AP 102-a, a b-STA of the AP 102-b, and the STA 104-b. In other words, the traffic flow may be associated with multiple hops. Accordingly, one or more of various wireless communication devices may protect the (periodic and low-latency) traffic flow from end-to-end (such as all the way through the network, including across the multiple hops).

At 604, the AP 102-b may transmit, to the network controller 402, a request for coordinated scheduling. The request for the coordinated scheduling may be, indicate, or include a request associated with the fronthaul schedule of time slots for communication of the traffic flow between the AP 102-b and the STA 104-b and a request associated with a backhaul schedule of time slots for communication of the traffic flow between the AP 102-a and the b-STA of the AP 102-b. In some examples, the AP 102-b may transmit the request for the coordinated scheduling by performing a 1905 or a 1905.1 forwarding of the frame (such as the SCS frame) received from the STA 104-b at 602. The request may additionally include, in some examples, information indicative of the fronthaul schedule of time slots (if established by the AP 102-b prior to transmission of the request at 604). For example, the request transmitted at 604 may be associated with or understood as a 1905.1 SCS+rTWT forwarding from the AP 102-b to the network controller 402.

The network controller 402 may store and maintain information indicative of one or more active schedules within the network and, accordingly, may have a complete view of the network pattern and the time slot allocation details across the entire network (such as the entire mesh network). In other words, the network controller 402 may have complete time axis knowledge of the (active) schedules of time slots across the network. Thus, in accordance with receiving the request for the coordinated scheduling at 604, the network controller 402 may configure, set, ascertain, determine, select, or identify time slots (such as one or more schedules of time slots) for the communication of the requested traffic flow in accordance with the other active schedules within the network. For example, the network controller 402 may assign two suitable schedules of time slots to the AP 102-a and the AP 102-b (such as a backhaul schedule of time slots for the AP 102-a and a fronthaul schedule of time slots for the AP 102-b) such that time slots of the two suitable schedules avoid overlapping or conflicting with other active schedules within the network.

At 606, for example, the network controller 402 may transmit or otherwise provide a configuration of a coordinated fronthaul schedule of time slots to the AP 102-b. In implementations in which the AP 102-b indicated an established fronthaul schedule of time slots via the request transmitted at 604, the configuration of the coordinated fronthaul schedule of time slots may include or indicate a confirmation or approval of the indicated fronthaul schedule of time slots, a rejection or decline of the indicated fronthaul schedule of time slots, or an update or adjustment to the indicated fronthaul schedule of time slots. In implementations in which the AP 102-b refrained from indicating an established fronthaul schedule of time slots via the request transmitted at 604, the configuration of the coordinated fronthaul schedule of time slots may include or indicate information indicative of a coordinated fronthaul schedule of time slots that the AP 102-b may establish and in accordance with which the AP 102-b may communicate. In some aspects, the configuration transmitted by the network controller 402 at 606 may be associated with or understood as a 1905.1 SCS+C-rTWT configuration to the AP 102-b.

At 608, for further example, the network controller 402 may transmit or otherwise provide a configuration of a coordinated backhaul schedule of time slots to the AP 102-a. In some implementations, the network controller 402 may establish the coordinated backhaul schedule of time slots for communication between the AP 102-a and the b-STA of the AP 102-b such that one or more time slots of the backhaul schedule of time slots are consecutive in time (such as immediately consecutive in time and non-overlapping) with one or more time slots of the fronthaul schedule of time slots. In some other implementations, time slots of the backhaul schedule of time slots may not be consecutive in time with time slots of the fronthaul schedule of time slots. In some aspects, the configuration transmitted by the network controller 402 at 608 may be associated with or understood as a 1905.1 SCS+C-rTWT configuration to the AP 102-a.

At 610, the AP 102-b may perform a coordinated scheduling advertisement, such as by transmitting information indicative of the coordinated fronthaul schedule of time slots via advertising broadcast signaling. The AP 102-b may transmit such information via one or more of various frame types, including a management frame (such as a beacon frame), an announcement frame, a trigger frame, or a data frame. The AP 102-a and the AP 102-c may receive the information indicative of the coordinated fronthaul schedule of time slots in accordance with the advertising broadcast signaling from the AP 102-b and each of the AP 102-a and the AP 102-c may propagate (such as transmit or relay) the information indicative of the coordinated fronthaul schedule of time slots to their respective BSSs (both in fronthaul and backhaul). In this manner, the AP 102-a and the AP 102-c, along with any client devices of the AP 102-a and the AP 102-c (such as the STA 104-a and the STA 104-c), may end or terminate any ongoing TXOP or transmissions before or at a start of a time slot of the coordinated fronthaul schedule of time slots advertised by the AP 102-b. In other words, the AP 102-a and the AP 102-c, as well as their in-BSS STAs 104, may respect the coordinated fronthaul schedule of time slots advertised by the AP 102-b. In-BSS STAs 104 of the AP 102-b also may respect the coordinated fronthaul schedule of time slots advertised by the AP 102-b.

At 612, the AP 102-a may perform a coordinated scheduling advertisement, such as by transmitting information indicative of the coordinated backhaul schedule of time slots via advertising broadcast signaling. The AP 102-a may transmit such information via one or more of various frame types, including a management frame (such as a beacon frame), an announcement frame, a trigger frame, or a data frame. The AP 102-b and the AP 102-c may receive the information indicative of the coordinated backhaul schedule of time slots in accordance with the advertising broadcast signaling from the AP 102-a and each of the AP 102-b and the AP 102-c may propagate (such as transmit or relay) the information indicative of the coordinated backhaul schedule of time slots to their respective BSSs (both in fronthaul and backhaul). In this manner, the AP 102-b and the AP 102-c, along with any client devices of the AP 102-b and the AP 102-c (such as the STA 104-b and the STA 104-c), may end or terminate any ongoing TXOP or transmissions before or at a start of a time slot of the coordinated backhaul schedule of time slots advertised by the AP 102-a. In other words, the AP 102-b and the AP 102-c, as well as their in-BSS STAs 104, may respect the coordinated backhaul schedule of time slots advertised by the AP 102-a. In-BSS STAs 104 of the AP 102-a also may respect the coordinated backhaul schedule of time slots advertised by the AP 102-a.

In accordance with such signaling mechanisms between the AP 102-a, the AP 102-b, the STA 104-b, and the network controller 402, such wireless communication devices may establish or create an end-to-end schedule of time slots (with such an end-to-end schedule of time slots being associated with, for example, a combination of the fronthaul schedule of time slots and the backhaul schedule of time slots) to protect chain transmissions associated with the end-to-end SLA flow between the AP 102-a and the STA 104-b. Further, a wireless communication device may group two or more SLA flows within a single time slot (or within a single schedule of time slots) if arrival patterns and periodicities of the two or more SLA flows (approximately) match each other. Additionally, or alternatively, a wireless communication device may decide to serve an SLA flow without the protection of a coordinated schedule of time slots or to reject an SCS request (for an SLA flow) if one or more conditions are satisfied. Such conditions may include, for example, if a corresponding schedule of time slots conflicts (or would conflict) with an incumbent coordinated schedule of time slots (of self or an OBSS) or if time slot allocation along the time axis becomes too granular (such as if time slots become less than a threshold duration or expect more than a threshold amount of precision across the network), which might make it difficult for the network to synchronize through the fronthaul and backhaul of multiple nodes.

At 614, in accordance with the establishment of the backhaul schedule of time slots and the fronthaul schedule of time slots for the end-to-end SLA flow, the AP 102-a may perform a first scheduled slot transmission (illustrated as “TX” in the example of the process flow 600). Such a first scheduled slot transmission may refer to or include a transmission of a data frame, a trigger frame, an announcement frame, or a TXS frame within a first time slot of the backhaul schedule of time slots.

At 616, and in association with receiving the first scheduled slot transmission at 614, the AP 102-b may perform a second scheduled slot transmission. Such a second scheduled slot transmission may refer to or include a transmission of a data frame, a trigger frame, or a TXS frame within a first time slot of the fronthaul schedule of time slots. In some implementations, the first time slot of the backhaul schedule of time slots and the first time slot of the fronthaul schedule of time slots may be consecutive in time. Alternatively, such a second scheduled slot transmission may refer to or include a transmission of a data frame, a trigger frame, or a TXS frame within the first time slot of the backhaul schedule of time slots (in examples in which the AP 102-a shares a portion of the first time slot of the backhaul schedule of time slots with the AP 102-b).

At 618, and in association with receiving the second scheduled slot transmission at 616, the STA 104-b may perform a third scheduled slot transmission. Such a third scheduled slot transmission may refer to or include a transmission of a data frame or a TXOP return frame within a second time slot of the fronthaul schedule of time slots. Alternatively, such a third scheduled slot transmission may refer to or include a transmission of a data frame or a TXOP return frame within the first time slot of the fronthaul schedule of time slots (in examples in which the AP 102-b shares a portion of the first time slot of the fronthaul schedule of time slots with the STA 104-b).

At 620, and in association with receiving the third scheduled slot transmission at 618, the AP 102-b may perform a fourth scheduled slot transmission. Such a fourth scheduled slot transmission may refer to or include a transmission of a data frame or a TXOP return frame within a second time slot of the backhaul schedule of time slots. In some implementations, the second time slot of the backhaul schedule of time slots and the second time slot of the fronthaul schedule of time slots may be consecutive in time. Alternatively, such a fourth scheduled slot transmission may refer to or include a transmission of a data frame or a TXOP return frame within the second time slot of the fronthaul schedule of time slots (in examples in which the STA 104-b shares a portion of the second time slot of the fronthaul schedule of time slots with the AP 102-b).

At 622, the AP 102-c may, in some implementations, perform a non-scheduled slot transmission. For example, if the AP 102-c ascertains, measures, or otherwise determines that the non-scheduled slot transmission will not interfere with the communication of the end-to-end SLA flow between the AP 102-a and the STA 104-b, the AP 102-c may perform the non-scheduled slot transmission to the STA 104-c associated with the AP 102-c.

In some implementations, the network controller 402 may continuously, periodically, aperiodically (such as on-demand), or semi-persistently update schedules of time slots across the nodes in accordance with a new arrival of an SLA flow or a change to an ongoing SLA flow in any part of the network. Additionally, or alternatively, the network controller 402 may perform scheduled updates of one or more schedules of time slots in accordance with a current arrival pattern and periodicity of SLA flows (in accordance with the comprehensive view of the network that is held, such as stored and maintained, by the network controller 402). For example, if an arrival pattern or a periodicity of an end-to-end SLA flow changes, the network controller 402 may transmit information indicative of one or more updated schedules of time slots to one or more nodes to adapt one or more previously established schedules of time slots to the new arrival pattern or the new periodicity.

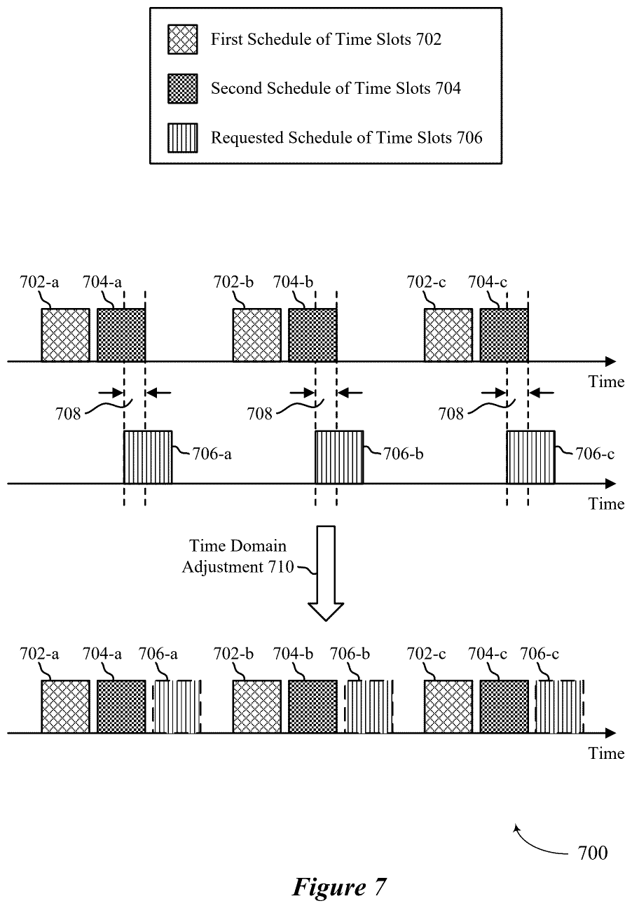

FIG. 7 shows an example conflict resolution procedure 700 that supports coordinated scheduling-based protocols for multi-hop traffic flows in a controller-based network. The conflict resolution procedure 700 may be implemented to realize one or more aspects of the wireless communication network 100, the wireless communication network 200, the network deployment scenario 300, the network deployment scenario 400, the process flow 500, or the process flow 600. For example, a wireless communication device (such as the AP 102-a, the AP 102-b, the AP 102-c, or the network controller 402 as illustrated by and described with reference to one or more of FIGS. 3-6) may perform the conflict resolution procedure 700 to resolve a conflict (such as a time domain overlapping) between two or more schedules of time slots.

For example, one or more of the AP 102-a, the AP 102-b, the AP 102-c, and the network controller 402 may support one or more signaling- or configuration-based mechanisms associated with conflict resolution between two or more overlapping schedules of time slots. In the example illustrated by the conflict resolution procedure 700, various wireless communication devices may establish (such as create and advertise, such as coordinate) a first schedule of time slots 702 and a second schedule of time slots 704 and a wireless communication device may receive an indication of a requested schedule of time slots 706. In some examples, the first schedule of time slots 702 may be a fronthaul schedule of time slots and the second schedule of time slots 704 may be a backhaul schedule of time slots, or vice versa, for an end-to-end SLA traffic flow. The first schedule of time slots 702 may include a time slot 702-a, a time slot 702-b, and a time slot 702-c; the second schedule of time slots 704 may include a time slot 704-a, a time slot 704-b, and a time slot 704-c; and the requested schedule of time slots 706 may include a time slot 706-a, a time slot 706-b, and a time slot 706-c. Although each schedule is illustrated as including three time slots in the example of the conflict resolution procedure 700, a schedule of time slots may include any quantity of time slots without exceeding the scope of the present disclosure.

The wireless communication device may implement the conflict resolution procedure 700 to resolve the conflict (such as the time domain overlap) in examples in which the requested schedule of time slots 706 includes one or more time slots that at least partially overlap with one or more time slots of the first schedule of time slots 702 or the second schedule of time slots 704. For example, if the time slots of the requested schedule of time slots 706 have a time domain overlap 708 with time slots of the second schedule of time slots 702, the wireless communication device may perform the conflict resolution procedure 700 to resolve (such as to remove or avoid) the time domain overlap 708. In some implementations, the wireless communication device may perform the conflict resolution procedure 700 by selecting, applying, identifying, calculating, receiving information indicative of, or transmitting information indicative of a time domain adjustment 710 to one or more schedules of time slots.

A wireless communication device may apply a time domain adjustment 710 to a schedule of time slots in one or more of various ways. In some implementations, a wireless communication device may apply a time domain adjustment 710 by shifting a wake time, by increasing or decreasing a wake duration, by increasing or decreasing a wake interval, or by rejecting the schedule of time slots. A wireless communication device may apply (and transmit information indicative of) a time domain adjustment 710 to a single schedule of time slots (such as one of the second schedule of time slots 704 and the requested schedule of time slots 706) or may apply (and transmit information indicative of) two or more time domain adjustments 710 to two or more schedules of time slots (such as a first time domain adjustment 710 to the second schedule of time slots 704 and a second time domain adjustment 710 to the requested schedule of time slots 706).

In examples in which an AP 102 (such as the AP 102-a, the AP 102-b, or the AP 102-c) receives a schedule request conflicting with an incumbent (coordinated) schedule, the AP 102 may resolve the conflict in accordance with one or more steps that depend on whether the incumbent schedule (such as the second schedule of time slots 704 in the example of the conflict resolution procedure 700) is owned or associated with the AP 102 or is owned or associated with an OBSS (such as another) AP 102. For example, if the second schedule of time slots 704 is owned or associated with the AP 102, the AP 102 may independently perform the conflict resolution procedure 700 (such as without coordination with or relying on signaling from the network controller 402). Alternatively, if the second schedule of time slots 704 is owned or associated with an OBSS AP 102, the AP 102 may independently perform the conflict resolution procedure 700 or may coordinate with the network controller 402 on the conflict resolution procedure 700.

In examples in which the second schedule of time slots 704 is owned or associated with the AP 102, the AP 102 may independently perform the conflict resolution procedure 700 by ascertaining, measuring, identifying, selecting, or determining whether a bandwidth associated with the second schedule of time slots 704 is able to accommodate the traffic load assigned to the requested schedule of time slots 706. In other words, the AP 102 may determine whether a bandwidth associated with the second schedule of time slots 704 is able to accommodate both a first traffic flow associated with the second schedule of time slots 704 and a second traffic flow associated with the requested schedule of time slots 706.

In examples in which the AP 102 determines that the bandwidth is sufficient to accommodate both traffic flows, the AP 102 may merge the second schedule of time slots 704 and the requested schedule of time slots 706 or may allow the time domain overlap 708 (such as without a time domain adjustment 710). In examples in which the AP 102 determines that the bandwidth is insufficient to accommodate both traffic flows, the AP 102 may identify a lower priority traffic flow of the two traffic flows and may adjust the schedule of time slots associated with the lower priority traffic flow. For example, the AP 102 may determine that a first priority associated with the first traffic flow is higher than a second priority associated with the second traffic flow and, accordingly, may apply the time domain adjustment 710 to the requested schedule of time slots 706. Alternatively, the AP 102 may determine that second priority is higher than the first priority and, accordingly, may apply the time domain adjustment 710 to the second schedule of time slots 704 (and, potentially, also to the first schedule of time slots 702).

In examples in which the second schedule of time slots 704 is owned or associated with an OBSS AP 102, the AP 102 may, in some implementations, transmit a request to the network controller 402 (a central or mesh network controller) for arbitration between the second schedule of time slots 704 and the requested schedule of time slots 706. The network controller 402 may receive the request and may apply the time domain adjustment 710 to the second schedule of time slots 704 or the requested schedule of time slots 706, or both, in accordance with a relative priority of the traffic flows carried by the second schedule of time slots 704 and the requested schedule of time slots 706. For example, the network controller 402 may apply the time domain adjustment 710 to the requested schedule of time slots 706 in examples in which the first priority associated with the first traffic flow is greater than the second priority associated with the second traffic flow. Alternatively, the network controller 402 may apply the time domain adjustment 710 to the second schedule of time slots 704 in examples in which the second priority associated with the second traffic flow is greater than the first priority associated with the first traffic flow.

In some other implementations, the AP 102 may apply the time domain adjustment 710 to the requested schedule of time slots 706 without coordination with the network controller 402 (as the AP 102 may have control and authority over its own schedules). Additionally, or alternatively, the AP 102 may inform the OBSS AP 102 (such as the owner AP 102 of the second schedule of time slots 704) that the AP 102 rescinds the second schedule of time slots 704 from a previous agreement. In such implementations, the AP 102 may rescind the second schedule of time slots 704 from the previous agreement (such that the AP 102 may no longer respect or honor the second schedule of time slots 704) in accordance with a relative priority of the traffic flows carried by the second schedule of time slots 704 and the requested schedule of time slots 706 or in accordance with another policy. For example, the AP 102 may rescind the second schedule of time slots 704 from the previous agreement in examples in which the second priority associated with the second traffic flow is greater than the first priority associated with the first traffic flow. Alternatively, in examples in which the first priority is greater than the second priority, the AP 102 may refrain from rescinding the second schedule of time slots 704 from the previous agreement (and, for example, may instead apply the time domain adjustment 710 to the requested schedule of time slots 706).

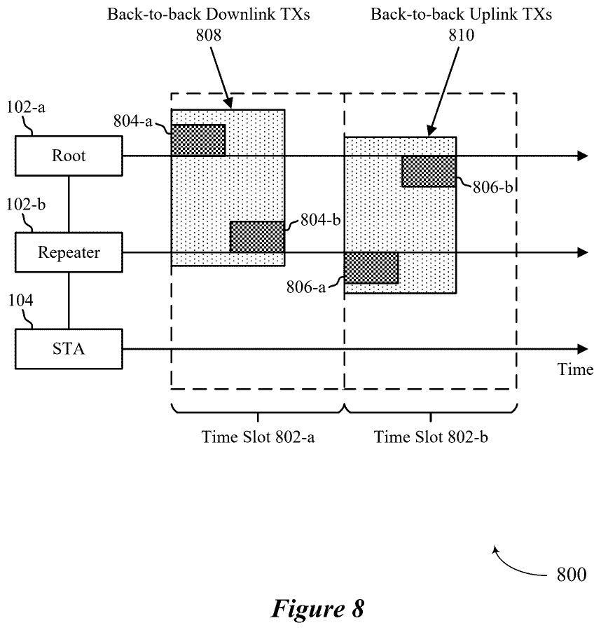

FIG. 8 shows an example multi-hop transmission sequence 800 that supports coordinated scheduling-based protocols for multi-hop traffic flows in a controller-based network. The multi-hop transmission sequence 800 may implement or may be implemented to realize one or more aspects of the wireless communication network 100, the wireless communication network 200, the network deployment scenario 300, the network deployment scenario 400, the process flow 500, the process flow 600, or the conflict resolution procedure 700. For example, the multi-hop transmission sequence 800 illustrates communication between or involving an AP 102-a, an AP 102-b, and a STA 104 (such as a client device). The AP 102-a (which may be a root AP 102) and the AP 102-b (which may be a repeater AP 102) of FIG. 8 may be examples of the AP 102-a and the AP 102-b, respectively, as illustrated by and described with reference to FIGS. 3-6. The STA 104 may be an example of a STA 104 as illustrated by and described with reference to FIGS. 1-6, such as the STA 104-b as illustrated by and described with reference to FIGS. 3, 5, and 6. In some implementations, the multi-hop transmission sequence 800 may be associated with a combination of a coordinated scheduling-based protocol with coordinated TDMA (C-TDMA) in a multi-hop (such as mesh) network or scenario for end-to-end ultra-low-latency.

In accordance with some example implementations, one or more of the AP 102-a, the AP 102-b, and the STA 104 may enable, facilitate, or configure back-to-back transmissions over multiple hops by establishing schedules of time slots for backhaul communication between the AP 102-a and for fronthaul communication between the AP 102-b and the STA 104. For example, one or more of the AP 102-a, the AP 102-b, and the STA 104, or a network controller 402, may establish a time slot 802-a within a backhaul schedule of time slots and may establish a time slot 802-b within a fronthaul schedule of time slots. The time slot 802-a and the time slot 802-b may be examples of coordinated time slots (such as time slots coordinated across multiple APs 102 via advertisement signaling or via configuration by a network controller 402 that has a complete view of the network).

The time slot 802-a may be owned by or otherwise associated with the AP 102-a and, in some examples, the AP 102-a may share at least a portion of the time slot 802-a with the AP 102-b (such as via C-TDMA TXOP sharing) for a downlink end-to-end transmission. For example, the AP 102-a may share at least a portion of the time slot 802-a with the AP 102-b to enable back-to-back (such as consecutive in time) downlink transmissions 808 including a downlink transmission 804-a from the AP 102-a to the AP 102-b and a downlink transmission 804-b from the AP 102-b to the STA 104. In such examples, the back-to-back downlink transmissions 808 may be understood as being enabled by C-TDMA within the time slot 802-a of the AP 102-a.

The time slot 802-b may be owned by or otherwise associated with the AP 102-b and, in some examples, the AP 102-b may share at least a portion of the time slot 802-b with the AP 102-a (such as via C-TDMA TXOP sharing) for an uplink end-to-end transmission. For example, the AP 102-b may share at least a portion of the time slot 802-b with the AP 102-a to enable back-to-back (such as consecutive in time) uplink transmissions 810 including an uplink transmission 806-a from the STA 104 to the AP 102-b and an uplink transmission 806-b from the AP 102-b to the AP 102-a. In such examples, the back-to-back uplink transmissions 810 may be understood as being enabled by C-TDMA within the time slot 802-b of the AP 102-b. In some implementations, the fronthaul uplink transmission (such as the uplink transmission 806-a) may be triggered by the AP 102-b toward the STA 104 (such as via a Trigger frame). Further, in some implementations, the backhaul uplink transmission (such as the uplink transmission 806-b) may be triggered by the AP 102-a toward the b-STA of the AP 102-b (such as via a Trigger frame). Alternatively, the uplink end-to-end transmission (such as the back-to-back uplink transmissions 810) may be enabled by the b-STA of the AP 102-b for the payload sent to the AP 102-a in a TXOP owned by the AP 102-b.

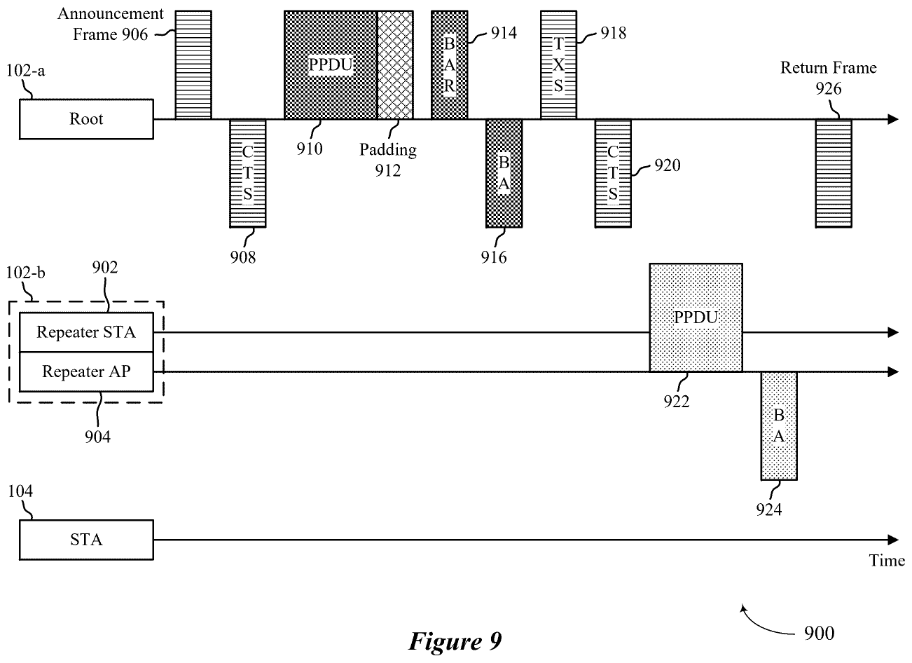

FIG. 9 shows an example communication sequence 900 that supports coordinated scheduling-based protocols for multi-hop traffic flows in a controller-based network. The communication sequence 900 may implement or may be implemented to realize one or more aspects of the wireless communication network 100, the wireless communication network 200, the network deployment scenario 300, the network deployment scenario 400, the process flow 500, the process flow 600, the conflict resolution procedure 700, or the multi-hop transmission sequence 800. For example, the communication sequence 900 illustrates communication between or involving an AP 102-a, an AP 102-b, and a STA 104 (such as a client device). The AP 102-a (which may be a root AP 102) and the AP 102-b (which may be a repeater AP 102) of FIG. 9 may be examples of the AP 102-a and the AP 102-b, respectively, as illustrated by and described with reference to FIGS. 3-6 and 8. The STA 104 may be an example of a STA 104 as illustrated by and described with reference to FIGS. 1-6 and 8, such as the STA 104-b as illustrated by and described with reference to FIGS. 3, 5, and 6.

The AP 102-b may include or be associated with various roles or functionalities. For example, the AP 102-b may include or be associated with a role or functionality of a repeater STA 902 (which may be equivalently referred to as a b-STA) and a repeater AP 904. In some examples, the AP 102-b may communicate with the AP 102-a via or otherwise using the repeater STA 902 and may communicate with the STA 104 via or otherwise using the repeater AP 904.

In some aspects, the AP 102-a, the AP 102-b, and the STA 104 may communicate (such as transmit or receive, or both) in accordance with the communication sequence 900 within one or more time slots, such as one or more coordinated time slots. In other words, the signaling exchange illustrated by the communication sequence 900 may occur within a single time slot or may occur across multiple time slots. In some implementations, the AP 102-a, the AP 102-b, and the STA 104 may establish or receive information indicative of one or more schedules of time slots in accordance with one or both of the process flow 500 and the process flow 600, with the one or more schedules of time slots including the one or more time slots within which the signaling exchange illustrated by the communication sequence 900 occurs. In some aspects, the communication sequence 900 illustrates a C-TDMA downlink transmission sequence in a multi-hop (such as mesh) network or scenario.

In accordance with the communication sequence 900, the AP 102-a may transmit an announcement frame 906. In some aspects, the announcement frame 906 may indicate information, such as scheduling information, associated with a TXOP or time slot owned or associated with the AP 102-a. For example, the announcement frame 906 may indicate an expected, scheduled, likely, or anticipated breakdown of how the TXOP or time slot owned or associated with the AP 102-a will be used. The AP 102-b may receive the announcement frame 906 from the AP 102-a in accordance with AP-to-AP communication, such as via the repeater STA 902 or the repeater AP 904 of the AP 102-b.

In association with receiving the announcement frame 906, the AP 102-b may transmit a clear-to-send (CTS) frame 908. The AP 102-b may transmit the CTS frame 908 in accordance with AP-to-AP communication, such as via the repeater STA 902 or the repeater AP 904 of the AP 102-b. The AP 102-a may transmit a data PPDU 910 in accordance with receiving the CTS frame 908 and, in some examples, the data PPDU 910 may include padding 912. In some examples, the AP 102-a may transmit a block acknowledgment (BA) request (BAR) frame 914 in association with transmitting the data PPDU 910. The AP 102-b, via the repeater STA 902, may receive the BAR frame 914 and may transmit a BA frame 916 in accordance with (such as in response to) the BAR frame 914.

The AP 102-a may transmit a TXS frame 918 to share a TXOP of the AP 102-a with the AP 102-b in accordance with a successful communication of the data PPDU 910 from the AP 102-a to the AP 102-b. The AP 102-b may receive the TXS frame 918 in accordance with AP-to-AP communication, such as via the repeater STA 902 or the repeater AP 904 of the AP 102-b. In some aspects, a time duration between transmission of the announcement frame 906 and transmission of the TXS frame 918 may be associated with a time to prepare a schedule command, such as an indication of a schedule for a remainder of the TXOP or time slot owned by or associated with the AP 102-a. The AP 102-b, via the repeater STA 902 or the repeater AP 904, may transmit a CTS frame 920 in association with receiving the TXS frame 918.

The AP 102-b, in accordance with being allocated a portion of the TXOP of the AP 102-a, may transmit, to the STA 104 via the repeater AP 904, a data PPDU 922. In some examples, the data PPDU 922 may be a relayed or forwarded version of the data PPDU 910 received from the AP 102-a. For example, the AP 102-a and the AP 102-b may use the sharing of the TXOP of the AP 102-a to facilitate an end-to-end transmission from the AP 102-a to the STA 104 (via the AP 102-b). The STA 104 may transmit a BA frame 924 associated with (such as responsive to) the data PPDU 922. In accordance with receiving the BA frame 924, the AP 102-b may transmit, to the AP 102-a, a return frame 926. The AP 102-b may transmit the return frame 926 in accordance with AP-to-AP communication, such as via the repeater STA 902 or the repeater AP 904 of the AP 102-b. The return frame 926 may be an example of a TXOP return frame and the AP 102-b may transmit the return frame 926 in examples in which the AP 102-b is able to complete a scheduled communication (such as transmission of the data PPDU 922) prior to an expiration of an amount of time allocated to the AP 102-b by the TXS frame 918.

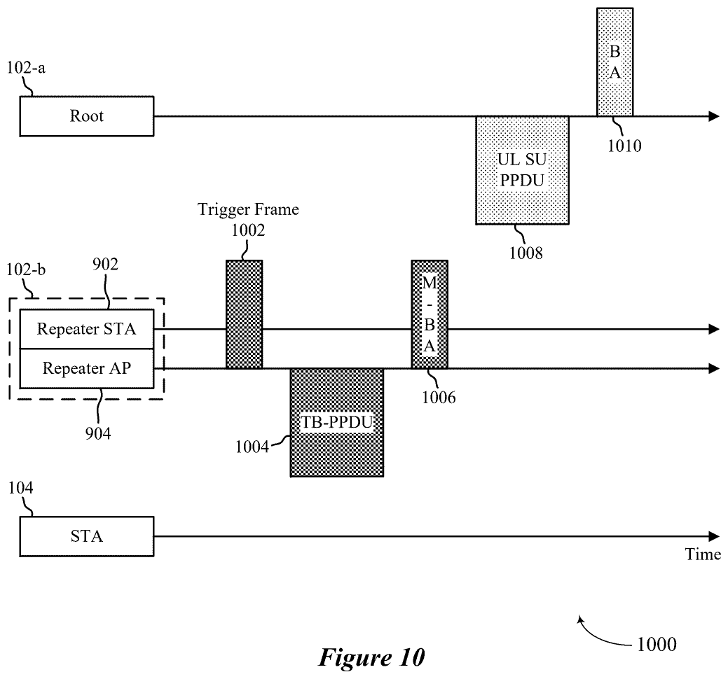

FIG. 10 shows an example communication sequence 1000 that supports coordinated scheduling-based protocols for multi-hop traffic flows in a controller-based network. The communication sequence 1000 may implement or may be implemented to realize one or more aspects of the wireless communication network 100, the wireless communication network 200, the network deployment scenario 300, the network deployment scenario 400, the process flow 500, the process flow 600, the conflict resolution procedure 700, or the multi-hop transmission sequence 800. For example, the communication sequence 1000 illustrates communication between or involving an AP 102-a, an AP 102-b, and a STA 104 (such as a client device). The AP 102-a (which may be a root AP 102) and the AP 102-b (which may be a repeater AP 102) of FIG. 10 may be examples of the AP 102-a and the AP 102-b, respectively, as illustrated by and described with reference to FIGS. 3-6 and 8. The STA 104 may be an example of a STA 104 as illustrated by and described with reference to FIGS. 1-6 and 8, such as the STA 104-b as illustrated by and described with reference to FIGS. 3, 5, and 6.

The AP 102-b may include or be associated with various roles or functionalities. For example, the AP 102-b may include or be associated with a role or functionality of a repeater STA 902 (which may be equivalently referred to as a b-STA) and a repeater AP 904, as also illustrated by and described with reference to FIG. 9. In some examples, the AP 102-b may communicate with the AP 102-a via or otherwise using the repeater STA 902 and may communicate with the STA 104 via or otherwise using the repeater AP 904.

In some aspects, the AP 102-a, the AP 102-b, and the STA 104 may communicate (such as transmit or receive, or both) in accordance with the communication sequence 1000 within one or more time slots, such as one or more coordinated time slots. In other words, the signaling exchange illustrated by the communication sequence 1000 may occur within a single time slot or may occur across multiple time slots. In some implementations, the AP 102-a, the AP 102-b, and the STA 104 may establish or receive information indicative of one or more schedules of time slots in accordance with one or both of the process flow 500 and the process flow 600, with the one or more schedules of time slots including the one or more time slots within which the signaling exchange illustrated by the communication sequence 1000 occurs. In some aspects, the communication sequence 1000 illustrates an uplink transmission sequence with an uplink single user (SU) PPDU in a multi-hop (such as mesh) network or scenario.

In accordance with the communication sequence 1000, the AP 102-b, via the repeater AP 904, may transmit a trigger frame 1002 to the STA 104. In some aspects, the trigger frame 1002 may solicit a trigger-based (TB) PPDU (TB-PPDU) from the STA 104. For example, in association with receiving the trigger frame 1002, the STA 104 may transmit a TB-PPDU 1004 to the AP 102-b, such as to the repeater AP 904 of the AP 102-b. In some examples, the AP 102-b, via the repeater AP 904, may transmit a multi-BA (M-BA) frame 1006 in association with receiving the TB-PPDU 1004. In some aspects, the repeater AP 904 may provide channel access (via, for example TXOP sharing) to the repeater STA 902, with which the repeater STA 902 may forward the data (such as the traffic) to a second hop (such as the AP 102-a). Further, in some aspects, the repeater STA 902 may have or maintain a designated MAC service data unit (MSDU) queue and MAC protocol data unit (MPDU) queue to include (such as contain) SCS traffic and the AP 102-b may prioritize MPDU queue scheduling for SCS flow carried by the TB-PPDU 1004 within the shared TXOP. Accordingly, the AP 102-b, via the repeater STA 902, may transmit an uplink SU PPDU 1008 to the AP 102-a (within a same TXOP in which the AP 102-b receives the TB-PPDU 1004). In some examples, the uplink SU PPDU 1008 may include data provided to the AP 102-b via the TB-PPDU 1004. In other words, the AP 102-b may relay data from the STA 104 to the AP 102-a in accordance with receiving the TB-PPDU 1004 and transmitting the uplink SU PPDU 1008. In some examples, the AP 102-a may transmit a BA frame 1010 in association with (such as in response to) receiving the 1008 from the AP 102-b.

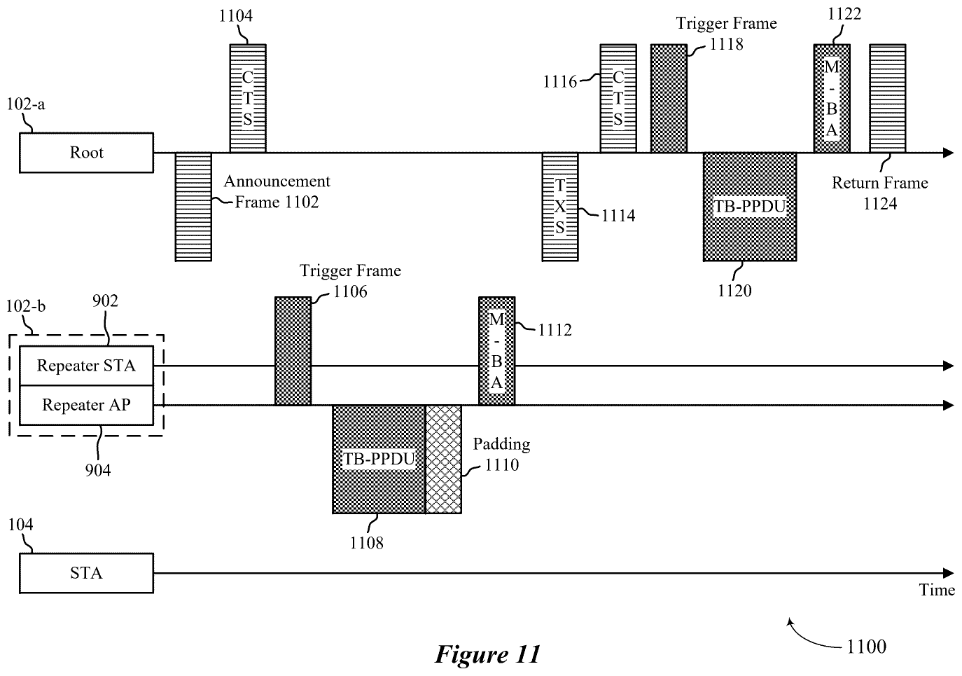

FIG. 11 shows an example communication sequence 1100 that supports coordinated scheduling-based protocols for multi-hop traffic flows in a controller-based network. The communication sequence 1100 may implement or may be implemented to realize one or more aspects of the wireless communication network 100, the wireless communication network 200, the network deployment scenario 300, the network deployment scenario 400, the process flow 500, the process flow 600, the conflict resolution procedure 700, or the multi-hop transmission sequence 800. For example, the communication sequence 1100 illustrates communication between or involving an AP 102-a, an AP 102-b, and a STA 104 (such as a client device). The AP 102-a (which may be a root AP 102) and the AP 102-b (which may be a repeater AP 102) of FIG. 11 may be examples of the AP 102-a and the AP 102-b, respectively, as illustrated by and described with reference to FIGS. 3-6 and 8. The STA 104 may be an example of a STA 104 as illustrated by and described with reference to FIGS. 1-6 and 8, such as the STA 104-b as illustrated by and described with reference to FIGS. 3, 5, and 6.

The AP 102-b may include or be associated with various roles or functionalities. For example, the AP 102-b may include or be associated with a role or functionality of a repeater STA 902 (which may be equivalently referred to as a b-STA) and a repeater AP 904, as also illustrated by and described with reference to FIG. 9. In some examples, the AP 102-b may communicate with the AP 102-a via or otherwise using the repeater STA 902 and may communicate with the STA 104 via or otherwise using the repeater AP 904.

In some aspects, the AP 102-a, the AP 102-b, and the STA 104 may communicate (such as transmit or receive, or both) in accordance with the communication sequence 1100 within one or more time slots, such as one or more coordinated time slots. In other words, the signaling exchange illustrated by the communication sequence 1100 may occur within a single time slot or may occur across multiple time slots. In some implementations, the AP 102-a, the AP 102-b, and the STA 104 may establish or receive information indicative of one or more schedules of time slots in accordance with one or both of the process flow 500 and the process flow 600, with the one or more schedules of time slots including the one or more time slots within which the signaling exchange illustrated by the communication sequence 1100 occurs. In some aspects, the communication sequence 1100 illustrates a C-TDMA uplink transmission sequence in a multi-hop (such as mesh) network or scenario.

In accordance with the communication sequence 1100, the AP 102-a may receive an announcement frame 1102 from the AP 102-b. The AP 102-b and the AP 102-a may communicate the announcement frame 1102 in accordance with AP-to-AP communication. For example, the AP 102-b may transmit the announcement frame 1102 via the repeater STA 902 or the repeater AP 904 of the AP 102-b. In some aspects, the announcement frame 1102 may indicate information, such as scheduling information, associated with a TXOP or time slot owned or associated with the AP 102-b. For example, the announcement frame 1102 may indicate an expected, scheduled, likely, or anticipated breakdown of how the TXOP or time slot owned or associated with the AP 102-b will be used. In other words, the repeater STA 902 or the repeater AP 904 may use the announcement frame 1102 to signal or indicate the (planned) usage of a shared TXOP to the AP 102-a. The announcement frame 1102 may indicate one or more of a transmission direction (such as downlink, uplink, or any), a traffic identifier (such as a traffic identifier (TID), a b-STA MAC address, or a b-STA SCS identifier (SCSID)), or a payload size.

The AP 102-a may transmit a CTS frame 1104 in association with receiving the announcement frame 1102. The AP 102-b may receive the CTS frame 1104 in accordance with AP-to-AP communication, such as via the repeater STA 902 or the repeater AP 904. In some implementations, the AP 102-a may create a schedule command in accordance with the announcement frame 1102 for a specific peer-TID, which may have priority over a schedule command created by a scheduler running on a random backoff (RBO). In some aspects, one or more wireless communication devices may communicate (such as transmit or receive, or both) information indicative of a mapping between [client MAC address, SCSID] and MSDU queue.

In accordance with the exchange of the announcement frame 1102 and the CTS frame 1104, the repeater AP 904 of the AP 102-b may transmit a trigger frame 1106 to the STA 104. The trigger frame 1106 may solicit uplink data from the STA 104. For example, in association with receiving the trigger frame 1106, the STA 104 may transmit a TB-PPDU 1108 including uplink data. In some examples, the TB-PPDU 1108 may include padding 1110. In some examples, the AP 102-b, via the repeater AP 904, may transmit an M-BA frame 1112 in association with receiving the TB-PPDU 1108. In some examples, the AP 102-b may transmit, to the AP 102-a, a TXS frame 1114 sharing at least a portion of the TXOP of the AP 102-b with the AP 102-a. The AP 102-b may transmit the TXS frame 1114 to the AP 102-a in accordance with AP-to-AP communication, such as via the repeater STA 902 or the repeater AP 904 of the AP 102-b. The AP 102-a may transmit a CTS frame 1116 in association with receiving the TXS frame 1114. The AP 102-b may receive the CTS frame 1116 in accordance with AP-to-AP communication, such as via the repeater STA 902 or the repeater AP 904. In some implementations, a time duration between the announcement frame 1102 and the TXS frame 1114 may be associated with a time duration within which the AP 102-b may prepare a schedule command.

The AP 102-a, in association with receiving the TXS frame 1114 that shares a portion of the TXOP of the AP 102-b with the AP 102-a, may transmit a trigger frame 1118 to the AP 102-a. The AP 102-b may receive the trigger frame 1118 via the repeater STA 902 of the AP 102-b. In association with receiving the trigger frame 1118, the AP 102-b may transmit a TB-PPDU 1120 to the AP 102-a. The AP 102-b may transmit the TB-PPDU 1120 via the repeater STA 902 of the AP 102-b. The AP 102-a may transmit an M-BA frame 1122 in association with receiving the TB-PPDU 1120. In accordance with transmitting the M-BA frame 1122, the AP 102-a may transmit, to the AP 102-b, a return frame 1124. The AP 102-b may receive the return frame 1124 via the repeater STA 902 or the repeater AP 904 of the AP 102-b. The return frame 1124 may be an example of a TXOP return frame and the AP 102-a may transmit the return frame 1124 in examples in which the AP 102-a is able to complete a scheduled communication (such as reception of the TB-PPDU 1120) prior to an expiration of an amount of time allocated to the AP 102-a by the TXS frame 1114.

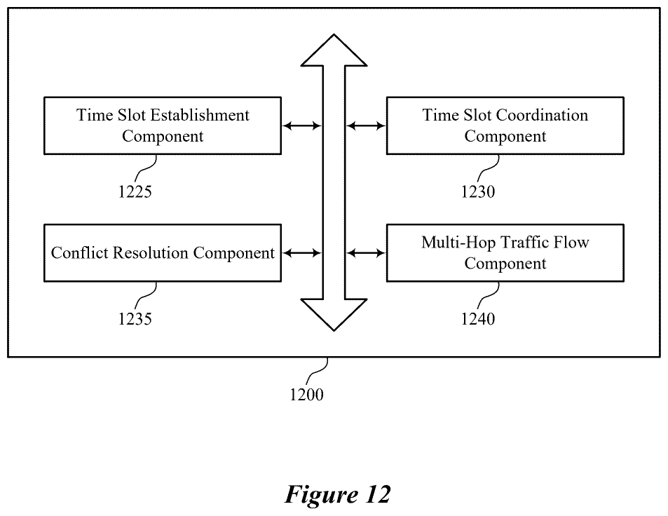

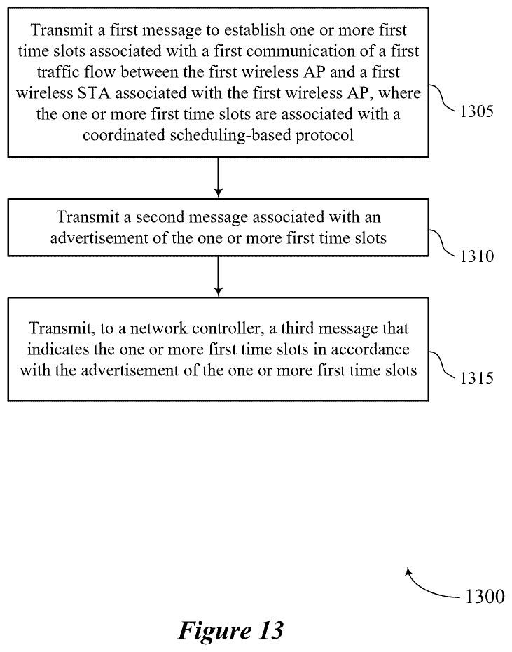

FIG. 12 shows a block diagram of an example wireless communication device 1200 that supports coordinated scheduling-based protocols for multi-hop traffic flows in a controller-based network. In some examples, the wireless communication device 1200 is configured to perform the processes 1300, 1400, 1500, 1600, and 1700 described with reference to FIGS. 13, 14, 15, 16, and 17, respectively. The wireless communication device 1200 may include one or more chips, SoCs, chipsets, packages, components or devices that individually or collectively constitute or include a processing system. The processing system may interface with other components of the wireless communication device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1200 may transmit the information output from the chip. In such an example, the second interface may refer to an interface between the processing system of the chip and a reception component, such that the wireless communication device 1200 may receive information that is then passed to the processing system. In some such examples, the first interface also may obtain information, such as from the transmission component, and the second interface also may output information, such as to the reception component.

The processing system of the wireless communication device 1200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein.

Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1200 can be configurable or configured for use in an AP, such as the AP 102 described with reference to FIG. 1, or a network controller, such as the network controller 402 described with reference to FIG. 4. In some other examples, the wireless communication device 1200 can be an AP or a network controller that includes such a processing system and other components including multiple antennas. The wireless communication device 1200 is capable of transmitting and receiving wireless communications in the form of, for example, wireless packets. For example, the wireless communication device 1200 can be configurable or configured to transmit and receive packets in the form of physical layer PPDUs and MPDUs conforming to one or more of the IEEE 802.11 family of wireless communication protocol standards. In some other examples, the wireless communication device 1200 can be configurable or configured to transmit and receive signals and communications conforming to one or more 3GPP specifications including those for 5G NR or 6G. In some examples, the wireless communication device 1200 also includes or can be coupled with one or more application processors which may be further coupled with one or more other memories. In some examples, the wireless communication device 1200 further includes at least one external network interface coupled with the processing system that enables communication with a core network or backhaul network that enables the wireless communication device 1200 to gain access to external networks including the Internet.

The wireless communication device 1200 includes a time slot establishment component 1225, a time slot coordination component 1230, a conflict resolution component 1235, and a multi-hop traffic flow component 1240. Portions of one or more of the time slot establishment component 1225, the time slot coordination component 1230, the conflict resolution component 1235, and the multi-hop traffic flow component 1240 may be implemented at least in part in hardware or firmware. For example, one or more of the time slot establishment component 1225, the time slot coordination component 1230, the conflict resolution component 1235, and the multi-hop traffic flow component 1240 may be implemented at least in part by at least a processor or a modem. In some examples, portions of one or more of the time slot establishment component 1225, the time slot coordination component 1230, the conflict resolution component 1235, and the multi-hop traffic flow component 1240 may be implemented at least in part by a processor and software in the form of processor-executable code stored in memory.

The wireless communication device 1200 may support wireless communication in accordance with examples as disclosed herein. The time slot establishment component 1225 is configurable or configured to transmit a first message to establish one or more first time slots associated with a first communication of a first traffic flow between the first wireless AP and a first wireless STA associated with the first wireless AP, where the one or more first time slots are associated with a coordinated scheduling-based protocol. The time slot coordination component 1230 is configurable or configured to transmit a second message associated with an advertisement of the one or more first time slots. In some examples, the time slot coordination component 1230 is configurable or configured to transmit, to a network controller, a third message that indicates the one or more first time slots in accordance with the advertisement of the one or more first time slots.

In some examples, the time slot establishment component 1225 is configurable or configured to transmit, to a second wireless AP, a request for the second wireless AP to establish time slots associated with a second communication of the first traffic flow between the first wireless AP and the second wireless AP. In some examples, the time slot establishment component 1225 is configurable or configured to receive, from the second wireless AP, an indication of one or more second time slots associated with the second communication of the first traffic flow between the first wireless AP and the second wireless AP in association with transmitting the request, where the one or more second time slots are associated with the coordinated scheduling-based protocol.

In some examples, the second wireless AP is a root AP associated with a network of wireless APs including the first wireless AP and the second wireless AP.

In some examples, the time slot coordination component 1230 is configurable or configured to transmit, to the network controller, information indicative of one or more requested time slots associated with a second communication of the first traffic flow between the first wireless AP and a second wireless AP. In some examples, the time slot establishment component 1225 is configurable or configured to receive, from the second wireless AP, an indication of one or more second time slots associated with the second communication of the first traffic flow between the first wireless AP and the second wireless AP in association with transmitting the information indicative of the one or more requested time slots, where the one or more second time slots are associated with the coordinated scheduling-based protocol.

In some examples, the one or more second time slots are advertised by the second wireless AP in accordance with the coordinated scheduling-based protocol. In some examples, the second wireless AP is a root AP associated with a network of wireless APs including the first wireless AP and the second wireless AP.

In some examples, the time slot coordination component 1230 is configurable or configured to receive a fourth message that indicates one or more requested time slots associated with a communication of a second traffic flow between the first wireless AP and a second wireless STA associated with the first wireless AP. In some examples, the conflict resolution component 1235 is configurable or configured to transmit a fifth message in association with receiving the fourth message, where a content of the fifth message is in accordance with whether the one or more requested time slots conflict with the one or more first time slots or one or more coordinated time slots associated with an OBSS wireless AP.

In some examples, the one or more requested time slots conflict with the one or more first time slots. In some examples, the content of the fifth message includes an indication of a time domain adjustment to the one or more first time slots in accordance with the one or more requested time slots being associated with a relatively higher priority than the one or more first time slots or the one or more requested time slots in accordance with the one or more first time slots being associated with a relatively higher priority than the one or more requested time slots.

In some examples, the one or more requested time slots conflict with the one or more first time slots. In some examples, a bandwidth of the one or more first time slots satisfies a threshold bandwidth to accommodate the first traffic flow and the second traffic flow. In some examples, the content of the fifth message includes an indication of a merging of the one or more requested time slots and the one or more first time slots or a confirmation of the one or more requested time slots.

In some examples, the one or more requested time slots conflict with the one or more coordinated time slots associated with the OBSS wireless AP. In some examples, the content of the fifth message includes an indication of a request for a network controller to mediate between the one or more requested time slots and the one or more coordinated time slots associated with the OBSS wireless AP.

In some examples, the conflict resolution component 1235 is configurable or configured to receive, from the network controller, a sixth message in association with transmitting the fifth message, where the sixth message indicates a time domain adjustment to the one or more requested time slots in accordance with the one or more coordinated time slots associated with the OBSS wireless AP associated with a relatively higher priority than the one or more requested time slots or a confirmation of the one or more requested time slots in accordance with the one or more requested time slots being associated with a relatively higher priority than the one or more coordinated time slots associated with the OBSS wireless AP.

In some examples, the one or more requested time slots conflict with the one or more coordinated time slots associated with the OBSS wireless AP. In some examples, the content of the fifth message includes an indication of a time domain adjustment to the one or more requested time slots.

In some examples, the time slot establishment component 1225 is configurable or configured to receive timing information associated with the first traffic flow, where the one or more first time slots are in accordance with the timing information.

In some examples, to support transmitting the third message to the network controller, the time slot establishment component 1225 is configurable or configured to transmit, via the third message, timing information associated with the first traffic flow.

Additionally, or alternatively, the wireless communication device 1200 may support wireless communication in accordance with examples as disclosed herein. In some examples, the time slot establishment component 1225 is configurable or configured to receive a first message that indicates one or more first time slots associated with a first communication of a first traffic flow between a first wireless AP and a first wireless STA associated with the first wireless AP, where the one or more first time slots are associated with a coordinated scheduling-based protocol. In some examples, the time slot coordination component 1230 is configurable or configured to receive a second message that indicates one or more requested time slots associated with a second communication of a second traffic flow between a second wireless AP and a second wireless STA associated with the second wireless AP, where the one or more requested time slots are associated with the coordinated scheduling-based protocol. The conflict resolution component 1235 is configurable or configured to transmit, in accordance with a conflict between the one or more first time slots and the one or more requested time slots, a third message that indicates a time domain adjustment to the one or more first time slots or the one or more requested time slots in accordance with a first priority associated with the first traffic flow and a second priority associated with the second traffic flow.

In some examples, the time domain adjustment to the one or more first time slots or the one or more requested time slots includes a first time domain adjustment to the one or more first time slots in accordance with the first priority being higher than the second priority or a second time domain adjustment to the one or more requested time slots in accordance with the second priority being higher than the first priority.

In some examples, the conflict resolution component 1235 is configurable or configured to transmit, to the first wireless AP, an indication of the first time domain adjustment to the one or more first time slots. In some examples, the conflict resolution component 1235 is configurable or configured to transmit, to the second wireless AP, an indication of the second time domain adjustment to the one or more requested time slots.

In some examples, the conflict resolution component 1235 is configurable or configured to transmit the indication of the first time domain adjustment to the one or more first time slots via the third message. In some examples, the conflict resolution component 1235 is configurable or configured to transmit the indication of the second time domain adjustment to the one or more requested time slots via a fourth message.

In some examples, the network controller stores information indicative of the one or more first time slots and the first priority associated with the first traffic flow in one or more memories associated with the network controller in accordance with the coordinated scheduling-based protocol. In some examples, the coordinated scheduling-based protocol is associated with a mediation of time slot allocations across a set of multiple wireless APs at the network controller.

In some examples, the time slot coordination component 1230 is configurable or configured to receive information indicative of one or more second requested time slots associated with a third communication of the first traffic flow between the first wireless AP and a third wireless AP. In some examples, the time slot establishment component 1225 is configurable or configured to transmit, to the third wireless AP, an indication of one or more second time slots associated with the third communication of the first traffic flow between the first wireless AP and the third wireless AP in association with receiving the information indicative of the one or more second requested time slots, where the one or more second time slots are associated with the coordinated scheduling-based protocol.

In some examples, the network controller receives the information indicative of the one or more second requested time slots from the first wireless AP.

In some examples, the network controller receives the information indicative of the one or more second requested time slots from the third wireless AP.

Additionally, or alternatively, the wireless communication device 1200 may support wireless communication in accordance with examples as disclosed herein. In some examples, the time slot coordination component 1230 is configurable or configured to transmit a first message that indicates a request for one or more coordinated time slots associated with a first communication of a first traffic flow between the first wireless AP and a first wireless STA associated with the first wireless AP. In some examples, the time slot establishment component 1225 is configurable or configured to receive a second message that indicates one or more first time slots associated with the first communication of the first traffic flow between the first wireless AP and the first wireless STA in accordance with the request, where the one or more first time slots are associated with a coordinated scheduling-based protocol. In some examples, the time slot coordination component 1230 is configurable or configured to transmit a third message associated with an advertisement of the one or more first time slots in accordance with receiving the second message.

In some examples, the time slot coordination component 1230 is configurable or configured to transmit, via the first message, timing information associated with the first traffic flow, where the one or more first time slots are in accordance with the timing information associated with the first traffic flow.

In some examples, the time slot coordination component 1230 is configurable or configured to receive timing information associated with the first traffic flow, where the request for the one or more coordinated time slots is in accordance with the timing information associated with the first traffic flow.

In some examples, the time slot establishment component 1225 is configurable or configured to receive a fourth message that indicates one or more second time slots associated with a second communication of the first traffic flow between the first wireless AP and a second wireless AP, where the one or more second time slots are associated with the coordinated scheduling-based protocol.

In some examples, the multi-hop traffic flow component 1240 is configurable or configured to communicate, with the first wireless STA, one or more first packets associated with the first traffic flow within the one or more first time slots. In some examples, the multi-hop traffic flow component 1240 is configurable or configured to communicate, with the second wireless AP, one or more second packets associated with the first traffic flow within the one or more second time slots.

In some examples, a first time slot of the one or more first time slots is consecutive in time with a second time slot of the one or more second time slots in accordance with the first traffic flow being associated with multiple hops. In some examples, the multiple hops include the first communication between the first wireless AP and the first wireless STA and the second communication between the first wireless AP and the second wireless AP.

In some examples, the second wireless AP is a root AP associated with a network of wireless APs including the first wireless AP and the second wireless AP.

In some examples, the time slot coordination component 1230 is configurable or configured to receive an indication of a time domain update to the one or more first time slots in accordance with a current arrival patten or a current periodicity associated with the first traffic flow.

In some examples, the request for the one or more coordinated time slots includes an indication of a service interval and a start time corresponding to an SLA associated with the first traffic flow or an indication of one or more requested time slots associated with the first communication of the first traffic flow between the first wireless AP and the first wireless STA.

Additionally, or alternatively, the wireless communication device 1200 may support wireless communication in accordance with examples as disclosed herein. In some examples, the time slot coordination component 1230 is configurable or configured to receive a first message that indicates a request for one or more coordinated time slots associated with a first communication of a first traffic flow between a first wireless AP and a first wireless STA associated with the first wireless AP. In some examples, the time slot establishment component 1225 is configurable or configured to transmit a second message that indicates one or more first time slots associated with the first communication of the first traffic flow between the first wireless AP and the first wireless STA, where the one or more first time slots are associated with a coordinated scheduling-based protocol. In some examples, the time slot establishment component 1225 is configurable or configured to transmit a third message that indicates one or more second time slots associated with a second communication of the first traffic flow between the first wireless AP and a second wireless AP, where the one or more second time slots are associated with the coordinated scheduling-based protocol.

In some examples, the time slot coordination component 1230 is configurable or configured to receive, via the first message, timing information associated with the first traffic flow, where the one or more first time slots or the one or more second time slots, or both, are in accordance with the timing information associated with the first traffic flow.

In some examples, the time slot coordination component 1230 is configurable or configured to receive a fourth message that indicates one or more requested time slots associated with a third communication of a second traffic flow between a third wireless AP and a second wireless STA associated with the third wireless AP. In some examples, the conflict resolution component 1235 is configurable or configured to transmit a fifth message in association with receiving the fourth message, where a content of the fifth message is in accordance with whether the one or more requested time slots conflict with the one or more first time slots or the one or more second time slots.

In some examples, the one or more requested time slots conflict with the one or more first time slots or the one or more second time slots. In some examples, the content of the fifth message includes an indication of a time domain adjustment to the one or more first time slots or the one or more second time slots in accordance with a second priority associated with the second traffic flow being higher than a first priority associated with the first traffic flow or the one or more requested time slots in accordance with the first priority associated with the first traffic flow being higher than the second priority associated with the second traffic flow.

In some examples, the one or more requested time slots do not conflict with the one or more first time slots or the one or more second time slots. In some examples, the content of the fifth message includes an indication of a confirmation of the one or more requested time slots.

In some examples, the network controller stores information indicative of the one or more first time slots, the one or more second time slots, and timing information associated with the first traffic flow in one or more memories associated with the network controller in accordance with the coordinated scheduling-based protocol. In some examples, the coordinated scheduling-based protocol at the network controller is associated with a mediation of time slot allocations across a set of multiple wireless APs at the network controller.

In some examples, the time slot coordination component 1230 is configurable or configured to transmit timing information associated with the first traffic flow, where the request for the one or more coordinated time slots is in accordance with the timing information associated with the first traffic flow.

In some examples, the time slot coordination component 1230 is configurable or configured to transmit an indication of a time domain update to the one or more first time slots or the one or more second time slots, or both, in accordance with a current arrival patten or a current periodicity associated with the first traffic flow.

In some examples, the request for the one or more coordinated time slots includes an indication of a service interval and a start time corresponding to an SLA associated with the first traffic flow or an indication of one or more requested time slots associated with the first communication of the first traffic flow between the first wireless AP and the first wireless STA.

In some examples, a first time slot of the one or more first time slots is consecutive in time with a second time slot of the one or more second time slots in accordance with the first traffic flow being associated with multiple hops. In some examples, the multiple hops include the first communication between the first wireless AP and the first wireless STA and the second communication between the first wireless AP and the second wireless AP.

In some examples, the second wireless AP is a root AP associated with a network of wireless APs including the first wireless AP and the second wireless AP.

Additionally, or alternatively, the wireless communication device 1200 may support wireless communication in accordance with examples as disclosed herein. In some examples, the time slot establishment component 1225 is configurable or configured to receive a first message that indicates one or more first time slots associated with a first communication of a first traffic flow between a second wireless AP and a wireless STA associated with the second wireless AP, where the one or more first time slots are associated with a coordinated scheduling-based protocol. In some examples, the time slot establishment component 1225 is configurable or configured to receive, from a network controller, a second message that indicates one or more second time slots associated with a second communication of the first traffic flow between the first wireless AP and the second wireless AP, where the one or more second time slots are associated with the coordinated scheduling-based protocol. In some examples, the time slot coordination component 1230 is configurable or configured to transmit a second message associated with an advertisement of the one or more second time slots.

In some examples, the time slot coordination component 1230 is configurable or configured to receive, via the second message, timing information associated with the first traffic flow, where the one or more second time slots are in accordance with the timing information associated with the first traffic flow.

In some examples, the time slot coordination component 1230 is configurable or configured to receive, from the second wireless AP, a third message that includes timing information associated with the first traffic flow. In some examples, the time slot coordination component 1230 is configurable or configured to transmit, to the network controller, a fourth message that includes an indication of one or more requested time slots associated with the second communication of the first traffic flow between the first wireless AP and the second wireless AP in association with receiving the third message from the second wireless AP, where receiving the second message that indicates the one or more second time slots is in association with transmitting the fourth message to the network controller.

In some examples, the conflict resolution component 1235 is configurable or configured to transmit the fourth message that includes the indication of the one or more requested time slots in accordance with the one or more requested time slots conflicting with one or more time slots associated with an OBSS wireless AP.

In some examples, the time slot coordination component 1230 is configurable or configured to transmit timing information associated with the first traffic flow, where the one or more first time slots or the one or more second time slots, or both, are in accordance with the timing information.

In some examples, the time slot coordination component 1230 is configurable or configured to receive an indication of a time domain update to the one or more second time slots in accordance with a current arrival patten or a current periodicity associated with the first traffic flow.

In some examples, a first time slot of the one or more first time slots is consecutive in time with a second time slot of the one or more second time slots in accordance with the first traffic flow being associated with multiple hops. In some examples, the multiple hops include the first communication between the second wireless AP and the wireless STA and the second communication between the first wireless AP and the second wireless AP.

In some examples, the multi-hop traffic flow component 1240 is configurable or configured to communicate, with the second wireless AP, one or more first packets associated with the first traffic flow within the one or more second time slots.

In some examples, the first wireless AP is a root AP associated with a network of wireless APs including the first wireless AP and the second wireless AP.

FIG. 13 shows a flowchart illustrating an example process 1300 performable by or at a first wireless AP that supports coordinated scheduling-based protocols for multi-hop traffic flows in a controller-based network. The operations of the process 1300 may be implemented by a first wireless AP or its components as described herein. For example, the process 1300 may be performed by a wireless communication device, such as the wireless communication device 1200 described with reference to FIG. 12, operating as or within a wireless AP. In some examples, the process 1300 may be performed by a wireless AP, such as one of the APs 102 described with reference to FIG. 1.

In some examples, in 1305, the first wireless AP may transmit a first message to establish one or more first time slots associated with a first communication of a first traffic flow between the first wireless AP and a first wireless STA associated with the first wireless AP, where the one or more first time slots are associated with a coordinated scheduling-based protocol. The operations of 1305 may be performed in accordance with examples as disclosed herein. In some implementations, aspects of the operations of 1305 may be performed by a time slot establishment component 1225 as described with reference to FIG. 12.

In some examples, in 1310, the first wireless AP may transmit a second message associated with an advertisement of the one or more first time slots. The operations of 1310 may be performed in accordance with examples as disclosed herein. In some implementations, aspects of the operations of 1310 may be performed by a time slot coordination component 1230 as described with reference to FIG. 12.

In some examples, in 1315, the first wireless AP may transmit, to a network controller, a third message that indicates the one or more first time slots in accordance with the advertisement of the one or more first time slots. The operations of 1315 may be performed in accordance with examples as disclosed herein. In some implementations, aspects of the operations of 1315 may be performed by a time slot coordination component 1230 as described with reference to FIG. 12.

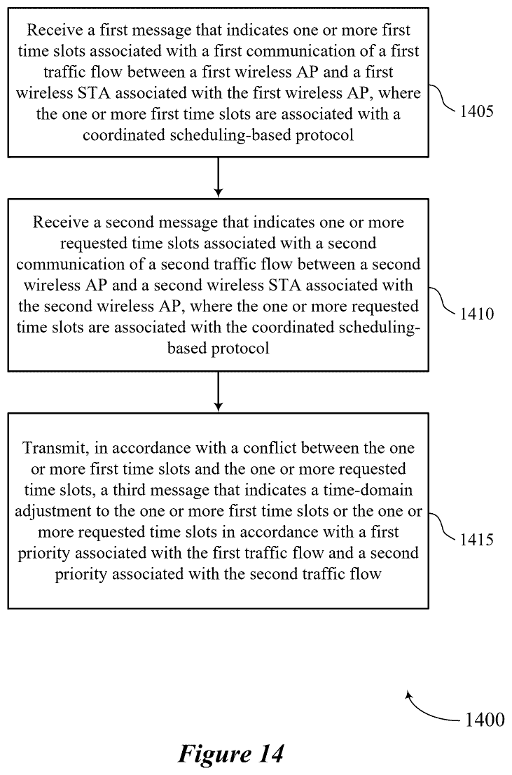

FIG. 14 shows a flowchart illustrating an example process 1400 performable by or at a network controller that supports coordinated scheduling-based protocols for multi-hop traffic flows in a controller-based network. The operations of the process 1400 may be implemented by a network controller or its components as described herein. For example, the process 1400 may be performed by a wireless communication device, such as the wireless communication device 1200 described with reference to FIG. 12, operating as or within a network controller. In some examples, the process 1400 may be performed by a network controller, such as the network controller 402 described with reference to FIG. 4.

In some examples, in 1405, the network controller may receive a first message that indicates one or more first time slots associated with a first communication of a first traffic flow between a first wireless AP and a first wireless STA associated with the first wireless AP, where the one or more first time slots are associated with a coordinated scheduling-based protocol. The operations of 1405 may be performed in accordance with examples as disclosed herein. In some implementations, aspects of the operations of 1405 may be performed by a time slot establishment component 1225 as described with reference to FIG. 12.

In some examples, in 1410, the network controller may receive a second message that indicates one or more requested time slots associated with a second communication of a second traffic flow between a second wireless AP and a second wireless STA associated with the second wireless AP, where the one or more requested time slots are associated with the coordinated scheduling-based protocol. The operations of 1410 may be performed in accordance with examples as disclosed herein. In some implementations, aspects of the operations of 1410 may be performed by a time slot coordination component 1230 as described with reference to FIG. 12.

In some examples, in 1415, the network controller may transmit, in accordance with a conflict between the one or more first time slots and the one or more requested time slots, a third message that indicates a time domain adjustment to the one or more first time slots or the one or more requested time slots in accordance with a first priority associated with the first traffic flow and a second priority associated with the second traffic flow. The operations of 1415 may be performed in accordance with examples as disclosed herein. In some implementations, aspects of the operations of 1415 may be performed by a conflict resolution component 1235 as described with reference to FIG. 12.

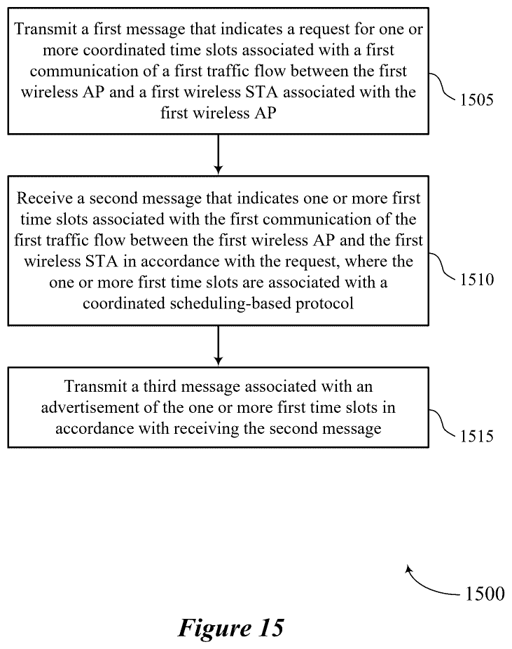

FIG. 15 shows a flowchart illustrating an example process 1500 performable by or at a first wireless AP that supports coordinated scheduling-based protocols for multi-hop traffic flows in a controller-based network. The operations of the process 1500 may be implemented by a first wireless AP or its components as described herein. For example, the process 1500 may be performed by a wireless communication device, such as the wireless communication device 1200 described with reference to FIG. 12, operating as or within a wireless AP. In some examples, the process 1500 may be performed by a wireless AP, such as one of the APs 102 described with reference to FIG. 1.

In some examples, in 1505, the first wireless AP may transmit a first message that indicates a request for one or more coordinated time slots associated with a first communication of a first traffic flow between the first wireless AP and a first wireless STA associated with the first wireless AP. The operations of 1505 may be performed in accordance with examples as disclosed herein. In some implementations, aspects of the operations of 1505 may be performed by a time slot coordination component 1230 as described with reference to FIG. 12.

In some examples, in 1510, the first wireless AP may receive a second message that indicates one or more first time slots associated with the first communication of the first traffic flow between the first wireless AP and the first wireless STA in accordance with the request, where the one or more first time slots are associated with a coordinated scheduling-based protocol. The operations of 1510 may be performed in accordance with examples as disclosed herein. In some implementations, aspects of the operations of 1510 may be performed by a time slot establishment component 1225 as described with reference to FIG. 12.

In some examples, in 1515, the first wireless AP may transmit a third message associated with an advertisement of the one or more first time slots in accordance with receiving the second message. The operations of 1515 may be performed in accordance with examples as disclosed herein. In some implementations, aspects of the operations of 1515 may be performed by a time slot coordination component 1230 as described with reference to FIG. 12.

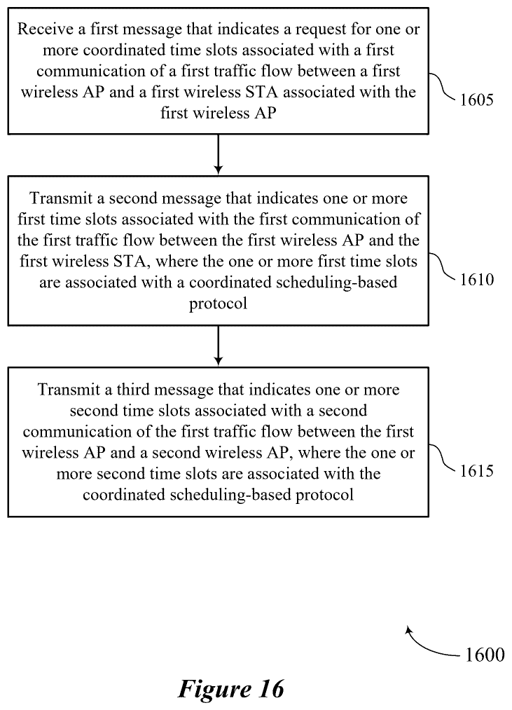

FIG. 16 shows a flowchart illustrating an example process 1600 performable by or at a network controller that supports coordinated scheduling-based protocols for multi-hop traffic flows in a controller-based network. The operations of the process 1600 may be implemented by a network controller or its components as described herein. For example, the process 1600 may be performed by a wireless communication device, such as the wireless communication device 1200 described with reference to FIG. 12, operating as or within a network controller. In some examples, the process 1600 may be performed by a network controller, such as the network controller 402 described with reference to FIG. 4.

In some examples, in 1605, the network controller may receive a first message that indicates a request for one or more coordinated time slots associated with a first communication of a first traffic flow between a first wireless AP and a first wireless STA associated with the first wireless AP. The operations of 1605 may be performed in accordance with examples as disclosed herein. In some implementations, aspects of the operations of 1605 may be performed by a time slot coordination component 1230 as described with reference to FIG. 12.

In some examples, in 1610, the network controller may transmit a second message that indicates one or more first time slots associated with the first communication of the first traffic flow between the first wireless AP and the first wireless STA, where the one or more first time slots are associated with a coordinated scheduling-based protocol. The operations of 1610 may be performed in accordance with examples as disclosed herein. In some implementations, aspects of the operations of 1610 may be performed by a time slot establishment component 1225 as described with reference to FIG. 12.

In some examples, in 1615, the network controller may transmit a third message that indicates one or more second time slots associated with a second communication of the first traffic flow between the first wireless AP and a second wireless AP, where the one or more second time slots are associated with the coordinated scheduling-based protocol. The operations of 1615 may be performed in accordance with examples as disclosed herein. In some implementations, aspects of the operations of 1615 may be performed by a time slot establishment component 1225 as described with reference to FIG. 12.

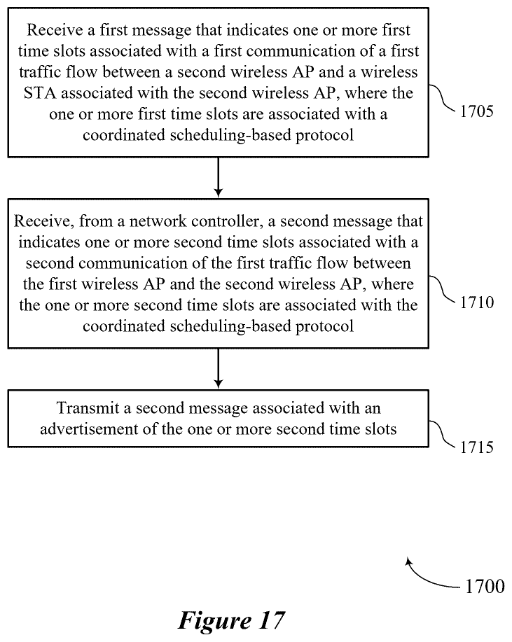

FIG. 17 shows a flowchart illustrating an example process 1700 performable by or at a first wireless AP that supports coordinated scheduling-based protocols for multi-hop traffic flows in a controller-based network. The operations of the process 1700 may be implemented by a first wireless AP or its components as described herein. For example, the process 1700 may be performed by a wireless communication device, such as the wireless communication device 1200 described with reference to FIG. 12, operating as or within a wireless AP. In some examples, the process 1700 may be performed by a wireless AP, such as one of the APs 102 described with reference to FIG. 1.

In some examples, in 1705, the first wireless AP may receive a first message that indicates one or more first time slots associated with a first communication of a first traffic flow between a second wireless AP and a wireless STA associated with the second wireless AP, where the one or more first time slots are associated with a coordinated scheduling-based protocol. The operations of 1705 may be performed in accordance with examples as disclosed herein. In some implementations, aspects of the operations of 1705 may be performed by a time slot establishment component 1225 as described with reference to FIG. 12.

In some examples, in 1710, the first wireless AP may receive, from a network controller, a second message that indicates one or more second time slots associated with a second communication of the first traffic flow between the first wireless AP and the second wireless AP, where the one or more second time slots are associated with the coordinated scheduling-based protocol. The operations of 1710 may be performed in accordance with examples as disclosed herein. In some implementations, aspects of the operations of 1710 may be performed by a time slot establishment component 1225 as described with reference to FIG. 12.

In some examples, in 1715, the first wireless AP may transmit a second message associated with an advertisement of the one or more second time slots. The operations of 1715 may be performed in accordance with examples as disclosed herein. In some implementations, aspects of the operations of 1715 may be performed by a time slot coordination component 1230 as described with reference to FIG. 12.

Implementation examples are described in the following numbered clauses:

Clause 1: A method for wireless communication at a first wireless AP, including: transmitting a first message to establish one or more first time slots associated with a first communication of a first traffic flow between the first wireless AP and a first wireless STA associated with the first wireless AP, where the one or more first time slots are associated with a coordinated scheduling-based protocol; transmitting a second message associated with an advertisement of the one or more first time slots; and transmitting, to a network controller, a third message that indicates the one or more first time slots in accordance with the advertisement of the one or more first time slots.

Clause 2: The method of clause 1, further including: transmitting, to a second wireless AP, a request for the second wireless AP to establish time slots associated with a second communication of the first traffic flow between the first wireless AP and the second wireless AP; and receiving, from the second wireless AP, an indication of one or more second time slots associated with the second communication of the first traffic flow between the first wireless AP and the second wireless AP in association with transmitting the request, where the one or more second time slots are associated with the coordinated scheduling-based protocol.

Clause 3: The method of clause 2, where the second wireless AP is a root AP associated with a network of wireless APs including the first wireless AP and the second wireless AP.

Clause 4: The method of any of clauses 1-3, further including: transmitting, to the network controller, information indicative of one or more requested time slots associated with a second communication of the first traffic flow between the first wireless AP and a second wireless AP; and receiving, from the second wireless AP, an indication of one or more second time slots associated with the second communication of the first traffic flow between the first wireless AP and the second wireless AP in association with transmitting the information indicative of the one or more requested time slots, where the one or more second time slots are associated with the coordinated scheduling-based protocol.

Clause 5: The method of clause 4, where the one or more second time slots are advertised by the second wireless AP in accordance with the coordinated scheduling-based protocol, and the second wireless AP is a root AP associated with a network of wireless APs including the first wireless AP and the second wireless AP.

Clause 6: The method of any of clauses 1-5, further including: receiving a fourth message that indicates one or more requested time slots associated with a communication of a second traffic flow between the first wireless AP and a second wireless STA associated with the first wireless AP; and transmitting a fifth message in association with receiving the fourth message, where a content of the fifth message is in accordance with whether the one or more requested time slots conflict with the one or more first time slots or one or more coordinated time slots associated with an OBSS wireless AP.

Clause 7: The method of clause 6, where the one or more requested time slots conflict with the one or more first time slots; and the content of the fifth message includes an indication of a time-domain adjustment to the one or more first time slots in accordance with the one or more requested time slots being associated with a relatively higher priority than the one or more first time slots or the one or more requested time slots in accordance with the one or more first time slots being associated with a relatively higher priority than the one or more requested time slots.

Clause 8: The method of any of clauses 6-7, where the one or more requested time slots conflict with the one or more first time slots; a bandwidth of the one or more first time slots satisfies a threshold bandwidth to accommodate the first traffic flow and the second traffic flow; and the content of the fifth message includes an indication of a merging of the one or more requested time slots and the one or more first time slots or a confirmation of the one or more requested time slots.

Clause 9: The method of any of clauses 6-8, where the one or more requested time slots conflict with the one or more coordinated time slots associated with the OBSS wireless AP; and the content of the fifth message includes an indication of a request for a network controller to mediate between the one or more requested time slots and the one or more coordinated time slots associated with the OBSS wireless AP.

Clause 10: The method of clause 9, further including: receiving, from the network controller, a sixth message in association with transmitting the fifth message, where the sixth message indicates a time-domain adjustment to the one or more requested time slots in accordance with the one or more coordinated time slots associated with the OBSS wireless AP associated with a relatively higher priority than the one or more requested time slots or a confirmation of the one or more requested time slots in accordance with the one or more requested time slots being associated with a relatively higher priority than the one or more coordinated time slots associated with the OBSS wireless AP.

Clause 11: The method of any of clauses 6-10, where the one or more requested time slots conflict with the one or more coordinated time slots associated with the OBSS wireless AP; and the content of the fifth message includes an indication of a time-domain adjustment to the one or more requested time slots.

Clause 12: The method of any of clauses 1-11, further including: receiving timing information associated with the first traffic flow, where the one or more first time slots are in accordance with the timing information.

Clause 13: The method of any of clauses 1-12, where transmitting the third message to the network controller includes: transmitting, via the third message, timing information associated with the first traffic flow.

Clause 14: A method for wireless communication at a network controller, including: receiving a first message that indicates one or more first time slots associated with a first communication of a first traffic flow between a first wireless AP and a first wireless STA associated with the first wireless AP, where the one or more first time slots are associated with a coordinated scheduling-based protocol; receiving a second message that indicates one or more requested time slots associated with a second communication of a second traffic flow between a second wireless AP and a second wireless STA associated with the second wireless AP, where the one or more requested time slots are associated with the coordinated scheduling-based protocol; and transmitting, in accordance with a conflict between the one or more first time slots and the one or more requested time slots, a third message that indicates a time-domain adjustment to the one or more first time slots or the one or more requested time slots in accordance with a first priority associated with the first traffic flow and a second priority associated with the second traffic flow.

Clause 15: The method of clause 14, where the time-domain adjustment to the one or more first time slots or the one or more requested time slots includes a first time-domain adjustment to the one or more first time slots in accordance with the first priority being higher than the second priority or a second time-domain adjustment to the one or more requested time slots in accordance with the second priority being higher than the first priority.

Clause 16: The method of clause 15, further including: transmitting, to the first wireless AP, an indication of the first time-domain adjustment to the one or more first time slots; or transmitting, to the second wireless AP, an indication of the second time-domain adjustment to the one or more requested time slots.

Clause 17: The method of clause 16, further including: transmitting the indication of the first time-domain adjustment to the one or more first time slots via the third message; and transmitting the indication of the second time-domain adjustment to the one or more requested time slots via a fourth message.

Clause 18: The method of any of clauses 14-17, where the network controller stores information indicative of the one or more first time slots and the first priority associated with the first traffic flow in one or more memories associated with the network controller in accordance with the coordinated scheduling-based protocol; and the coordinated scheduling-based protocol is associated with a mediation of time slot allocations across a set of multiple wireless APs at the network controller.

Clause 19: The method of any of clauses 14-18, further including: receiving information indicative of one or more second requested time slots associated with a third communication of the first traffic flow between the first wireless AP and a third wireless AP; and transmitting, to the third wireless AP, an indication of one or more second time slots associated with the third communication of the first traffic flow between the first wireless AP and the third wireless AP in association with receiving the information indicative of the one or more second requested time slots, where the one or more second time slots are associated with the coordinated scheduling-based protocol.

Clause 20: The method of clause 19, where the network controller receives the information indicative of the one or more second requested time slots from the first wireless AP.

Clause 21: The method of any of clauses 19-20, where the network controller receives the information indicative of the one or more second requested time slots from the third wireless AP.

Clause 22: A method for wireless communication at a first wireless AP, including: transmitting a first message that indicates a request for one or more coordinated time slots associated with a first communication of a first traffic flow between the first wireless AP and a first wireless STA associated with the first wireless AP; receiving a second message that indicates one or more first time slots associated with the first communication of the first traffic flow between the first wireless AP and the first wireless STA in accordance with the request, where the one or more first time slots are associated with a coordinated scheduling-based protocol; and transmitting a third message associated with an advertisement of the one or more first time slots in accordance with receiving the second message.

Clause 23: The method of clause 22, further including: transmitting, via the first message, timing information associated with the first traffic flow, where the one or more first time slots are in accordance with the timing information associated with the first traffic flow.

Clause 24: The method of any of clauses 22-23, further including: receiving timing information associated with the first traffic flow, where the request for the one or more coordinated time slots is in accordance with the timing information associated with the first traffic flow.

Clause 25: The method of any of clauses 22-24, further including: receiving a fourth message that indicates one or more second time slots associated with a second communication of the first traffic flow between the first wireless AP and a second wireless AP, where the one or more second time slots are associated with the coordinated scheduling-based protocol.

Clause 26: The method of clause 25, further including: communicating, with the first wireless STA, one or more first packets associated with the first traffic flow within the one or more first time slots; and communicating, with the second wireless AP, one or more second packets associated with the first traffic flow within the one or more second time slots.

Clause 27: The method of any of clauses 25-26, where a first time slot of the one or more first time slots is consecutive in time with a second time slot of the one or more second time slots in accordance with the first traffic flow being associated with multiple hops, and the multiple hops include the first communication between the first wireless AP and the first wireless STA and the second communication between the first wireless AP and the second wireless AP.

Clause 28: The method of any of clauses 25-27, where the second wireless AP is a root AP associated with a network of wireless APs including the first wireless AP and the second wireless AP.

Clause 29: The method of any of clauses 22-28, further including: receiving an indication of a time-domain update to the one or more first time slots in accordance with a current arrival patten or a current periodicity associated with the first traffic flow.

Clause 30: The method of any of clauses 22-29, where the request for the one or more coordinated time slots includes an indication of a service interval and a start time corresponding to an SLA associated with the first traffic flow or an indication of one or more requested time slots associated with the first communication of the first traffic flow between the first wireless AP and the first wireless STA.

Clause 31: A method for wireless communication at a network controller, including: receiving a first message that indicates a request for one or more coordinated time slots associated with a first communication of a first traffic flow between a first wireless AP and a first wireless STA associated with the first wireless AP; transmitting a second message that indicates one or more first time slots associated with the first communication of the first traffic flow between the first wireless AP and the first wireless STA, where the one or more first time slots are associated with a coordinated scheduling-based protocol; and transmitting a third message that indicates one or more second time slots associated with a second communication of the first traffic flow between the first wireless AP and a second wireless AP, where the one or more second time slots are associated with the coordinated scheduling-based protocol.

Clause 32: The method of clause 31, further including: receiving, via the first message, timing information associated with the first traffic flow, where the one or more first time slots or the one or more second time slots, or both, are in accordance with the timing information associated with the first traffic flow.

Clause 33: The method of clause 32, further including: receiving a fourth message that indicates one or more requested time slots associated with a third communication of a second traffic flow between a third wireless AP and a second wireless STA associated with the third wireless AP; and transmitting a fifth message in association with receiving the fourth message, where a content of the fifth message is in accordance with whether the one or more requested time slots conflict with the one or more first time slots or the one or more second time slots.

Clause 34: The method of clause 33, where the one or more requested time slots conflict with the one or more first time slots or the one or more second time slots; and the content of the fifth message includes an indication of a time-domain adjustment to the one or more first time slots or the one or more second time slots in accordance with a second priority associated with the second traffic flow being higher than a first priority associated with the first traffic flow or the one or more requested time slots in accordance with the first priority associated with the first traffic flow being higher than the second priority associated with the second traffic flow.

Clause 35: The method of any of clauses 33-34, where the one or more requested time slots do not conflict with the one or more first time slots or the one or more second time slots; and the content of the fifth message includes an indication of a confirmation of the one or more requested time slots.

Clause 36: The method of any of clauses 32-35, where the network controller stores information indicative of the one or more first time slots, the one or more second time slots, and timing information associated with the first traffic flow in one or more memories associated with the network controller in accordance with the coordinated scheduling-based protocol; and the coordinated scheduling-based protocol at the network controller is associated with a mediation of time slot allocations across a set of multiple wireless APs at the network controller.

Clause 37: The method of any of clauses 31-36, further including: transmitting timing information associated with the first traffic flow, where the request for the one or more coordinated time slots is in accordance with the timing information associated with the first traffic flow.

Clause 38: The method of any of clauses 31-37, further including: transmitting an indication of a time-domain update to the one or more first time slots or the one or more second time slots, or both, in accordance with a current arrival patten or a current periodicity associated with the first traffic flow.

Clause 39: The method of any of clauses 31-38, where the request for the one or more coordinated time slots includes an indication of a service interval and a start time corresponding to an SLA associated with the first traffic flow or an indication of one or more requested time slots associated with the first communication of the first traffic flow between the first wireless AP and the first wireless STA.

Clause 40: The method of any of clauses 31-39, where a first time slot of the one or more first time slots is consecutive in time with a second time slot of the one or more second time slots in accordance with the first traffic flow being associated with multiple hops, and the multiple hops include the first communication between the first wireless AP and the first wireless STA and the second communication between the first wireless AP and the second wireless AP.

Clause 41: The method of any of clauses 31-40, where the second wireless AP is a root AP associated with a network of wireless APs including the first wireless AP and the second wireless AP.

Clause 42: A method for wireless communication at a first wireless AP, including: receiving a first message that indicates one or more first time slots associated with a first communication of a first traffic flow between a second wireless AP and a wireless STA associated with the second wireless AP, where the one or more first time slots are associated with a coordinated scheduling-based protocol; and receiving, from a network controller, a second message that indicates one or more second time slots associated with a second communication of the first traffic flow between the first wireless AP and the second wireless AP, where the one or more second time slots are associated with the coordinated scheduling-based protocol; and transmitting a second message associated with an advertisement of the one or more second time slots.

Clause 43: The method of clause 42, further including: receiving, via the second message, timing information associated with the first traffic flow, where the one or more second time slots are in accordance with the timing information associated with the first traffic flow.

Clause 44: The method of any of clauses 42-43, further including: receiving, from the second wireless AP, a third message that includes timing information associated with the first traffic flow; and transmitting, to the network controller, a fourth message that includes an indication of one or more requested time slots associated with the second communication of the first traffic flow between the first wireless AP and the second wireless AP in association with receiving the third message from the second wireless AP, where receiving the second message that indicates the one or more second time slots is in association with transmitting the fourth message to the network controller.

Clause 45: The method of clause 44, further including: transmitting the fourth message that includes the indication of the one or more requested time slots in accordance with the one or more requested time slots conflicting with one or more time slots associated with an OBSS wireless AP.

Clause 46: The method of any of clauses 42-45, further including: transmitting timing information associated with the first traffic flow, where the one or more first time slots or the one or more second time slots, or both, are in accordance with the timing information.

Clause 47: The method of any of clauses 42-46, further including: receiving an indication of a time-domain update to the one or more second time slots in accordance with a current arrival patten or a current periodicity associated with the first traffic flow.

Clause 48: The method of any of clauses 42-47, where a first time slot of the one or more first time slots is consecutive in time with a second time slot of the one or more second time slots in accordance with the first traffic flow being associated with multiple hops, and the multiple hops include the first communication between the second wireless AP and the wireless STA and the second communication between the first wireless AP and the second wireless AP.

Clause 49: The method of any of clauses 42-48, further including: communicating, with the second wireless AP, one or more first packets associated with the first traffic flow within the one or more second time slots.

Clause 50: The method of any of clauses 42-49, where the first wireless AP is a root AP associated with a network of wireless APs including the first wireless AP and the second wireless AP.

Clause 51: A first wireless AP, including: a processing system that includes processor circuitry and memory circuitry that stores code, the processing system configured to cause the first wireless AP to: transmit a first message to establish one or more first time slots associated with a first communication of a first traffic flow between the first wireless AP and a first wireless STA associated with the first wireless AP, where the one or more first time slots are associated with a coordinated scheduling-based protocol; transmit a second message associated with an advertisement of the one or more first time slots; and transmit, to a network controller, a third message that indicates the one or more first time slots in accordance with the advertisement of the one or more first time slots.

Clause 52: The first wireless AP of clause 51, where the processing system is further configured to cause the first wireless AP to: transmit, to a second wireless AP, a request for the second wireless AP to establish time slots associated with a second communication of the first traffic flow between the first wireless AP and the second wireless AP; and receive, from the second wireless AP, an indication of one or more second time slots associated with the second communication of the first traffic flow between the first wireless AP and the second wireless AP in association with transmitting the request, where the one or more second time slots are associated with the coordinated scheduling-based protocol.

Clause 53: The first wireless AP of clause 52, where the second wireless AP is a root AP associated with a network of wireless APs including the first wireless AP and the second wireless AP.

Clause 54: The first wireless AP of any of clauses 51-53, where the processing system is further configured to cause the first wireless AP to: transmit, to the network controller, information indicative of one or more requested time slots associated with a second communication of the first traffic flow between the first wireless AP and a second wireless AP; and receive, from the second wireless AP, an indication of one or more second time slots associated with the second communication of the first traffic flow between the first wireless AP and the second wireless AP in association with transmitting the information indicative of the one or more requested time slots, where the one or more second time slots are associated with the coordinated scheduling-based protocol.

Clause 55: The first wireless AP of clause 54, where the one or more second time slots are advertised by the second wireless AP in accordance with the coordinated scheduling-based protocol, and the second wireless AP is a root AP associated with a network of wireless APs including the first wireless AP and the second wireless AP.

Clause 56: The first wireless AP of any of clauses 51-55, where the processing system is further configured to cause the first wireless AP to: receive a fourth message that indicates one or more requested time slots associated with a communication of a second traffic flow between the first wireless AP and a second wireless STA associated with the first wireless AP; and transmit a fifth message in association with receiving the fourth message, where a content of the fifth message is in accordance with whether the one or more requested time slots conflict with the one or more first time slots or one or more coordinated time slots associated with an OBSS wireless AP.

Clause 57: The first wireless AP of clause 56, where the one or more requested time slots conflict with the one or more first time slots; and the content of the fifth message includes an indication of a time-domain adjustment to the one or more first time slots in accordance with the one or more requested time slots being associated with a relatively higher priority than the one or more first time slots or the one or more requested time slots in accordance with the one or more first time slots being associated with a relatively higher priority than the one or more requested time slots.

Clause 58: The first wireless AP of any of clauses 56-57, where the one or more requested time slots conflict with the one or more first time slots; a bandwidth of the one or more first time slots satisfies a threshold bandwidth to accommodate the first traffic flow and the second traffic flow; and the content of the fifth message includes an indication of a merging of the one or more requested time slots and the one or more first time slots or a confirmation of the one or more requested time slots.

Clause 59: The first wireless AP of any of clauses 56-58, where the one or more requested time slots conflict with the one or more coordinated time slots associated with the OBSS wireless AP; and the content of the fifth message includes an indication of a request for a network controller to mediate between the one or more requested time slots and the one or more coordinated time slots associated with the OBSS wireless AP.

Clause 60: The first wireless AP of clause 59, where the processing system is further configured to cause the first wireless AP to: receive, from the network controller, a sixth message in association with transmitting the fifth message, where the sixth message indicates a time-domain adjustment to the one or more requested time slots in accordance with the one or more coordinated time slots associated with the OBSS wireless AP associated with a relatively higher priority than the one or more requested time slots or a confirmation of the one or more requested time slots in accordance with the one or more requested time slots being associated with a relatively higher priority than the one or more coordinated time slots associated with the OBSS wireless AP.

Clause 61: The first wireless AP of any of clauses 56-60, where the one or more requested time slots conflict with the one or more coordinated time slots associated with the OBSS wireless AP; and the content of the fifth message includes an indication of a time-domain adjustment to the one or more requested time slots.

Clause 62: The first wireless AP of any of clauses 51-61, where the processing system is further configured to cause the first wireless AP to: receive timing information associated with the first traffic flow, where the one or more first time slots are in accordance with the timing information.

Clause 63: The first wireless AP of any of clauses 51-62, where, to transmit the third message to the network controller, the processing system is configured to cause the first wireless AP to: transmit, via the third message, timing information associated with the first traffic flow.

Clause 64: A network controller, including: a processing system that includes processor circuitry and memory circuitry that stores code, the processing system configured to cause the network controller to: receive a first message that indicates one or more first time slots associated with a first communication of a first traffic flow between a first wireless AP and a first wireless STA associated with the first wireless AP, where the one or more first time slots are associated with a coordinated scheduling-based protocol; receive a second message that indicates one or more requested time slots associated with a second communication of a second traffic flow between a second wireless AP and a second wireless STA associated with the second wireless AP, where the one or more requested time slots are associated with the coordinated scheduling-based protocol; and transmit, in accordance with a conflict between the one or more first time slots and the one or more requested time slots, a third message that indicates a time-domain adjustment to the one or more first time slots or the one or more requested time slots in accordance with a first priority associated with the first traffic flow and a second priority associated with the second traffic flow.

Clause 65: The network controller of clause 64, where the time-domain adjustment to the one or more first time slots or the one or more requested time slots includes a first time-domain adjustment to the one or more first time slots in accordance with the first priority being higher than the second priority or a second time-domain adjustment to the one or more requested time slots in accordance with the second priority being higher than the first priority.

Clause 66: The network controller of clause 65, where the processing system is further configured to cause the network controller to: transmit, to the first wireless AP, an indication of the first time-domain adjustment to the one or more first time slots; or transmit, to the second wireless AP, an indication of the second time-domain adjustment to the one or more requested time slots.

Clause 67: The network controller of clause 66, where the processing system is further configured to cause the network controller to: transmit the indication of the first time-domain adjustment to the one or more first time slots via the third message; and transmit the indication of the second time-domain adjustment to the one or more requested time slots via a fourth message.

Clause 68: The network controller of any of clauses 64-67, where the network controller stores information indicative of the one or more first time slots and the first priority associated with the first traffic flow in one or more memories associated with the network controller in accordance with the coordinated scheduling-based protocol; and the coordinated scheduling-based protocol is associated with a mediation of time slot allocations across a set of multiple wireless APs at the network controller.

Clause 69: The network controller of any of clauses 64-68, where the processing system is further configured to cause the network controller to: receive information indicative of one or more second requested time slots associated with a third communication of the first traffic flow between the first wireless AP and a third wireless AP; and transmit, to the third wireless AP, an indication of one or more second time slots associated with the third communication of the first traffic flow between the first wireless AP and the third wireless AP in association with receiving the information indicative of the one or more second requested time slots, where the one or more second time slots are associated with the coordinated scheduling-based protocol.

Clause 70: The network controller of clause 69, where the network controller receives the information indicative of the one or more second requested time slots from the first wireless AP.

Clause 71: The network controller of any of clauses 69-70, where the network controller receives the information indicative of the one or more second requested time slots from the third wireless AP.

Clause 72: A first wireless AP, including: a processing system that includes processor circuitry and memory circuitry that stores code, the processing system configured to cause the first wireless AP to: transmit a first message that indicates a request for one or more coordinated time slots associated with a first communication of a first traffic flow between the first wireless AP and a first wireless STA associated with the first wireless AP; receive a second message that indicates one or more first time slots associated with the first communication of the first traffic flow between the first wireless AP and the first wireless STA in accordance with the request, where the one or more first time slots are associated with a coordinated scheduling-based protocol; and transmit a third message associated with an advertisement of the one or more first time slots in accordance with receiving the second message.

Clause 73: The first wireless AP of clause 72, where the processing system is further configured to cause the first wireless AP to: transmit, via the first message, timing information associated with the first traffic flow, where the one or more first time slots are in accordance with the timing information associated with the first traffic flow.

Clause 74: The first wireless AP of any of clauses 72-73, where the processing system is further configured to cause the first wireless AP to: receive timing information associated with the first traffic flow, where the request for the one or more coordinated time slots is in accordance with the timing information associated with the first traffic flow.

Clause 75: The first wireless AP of any of clauses 72-74, where the processing system is further configured to cause the first wireless AP to: receive a fourth message that indicates one or more second time slots associated with a second communication of the first traffic flow between the first wireless AP and a second wireless AP, where the one or more second time slots are associated with the coordinated scheduling-based protocol.

Clause 76: The first wireless AP of clause 75, where the processing system is further configured to cause the first wireless AP to: communicate, with the first wireless STA, one or more first packets associated with the first traffic flow within the one or more first time slots; and communicate, with the second wireless AP, one or more second packets associated with the first traffic flow within the one or more second time slots.

Clause 77: The first wireless AP of any of clauses 75-76, where a first time slot of the one or more first time slots is consecutive in time with a second time slot of the one or more second time slots in accordance with the first traffic flow being associated with multiple hops, and the multiple hops include the first communication between the first wireless AP and the first wireless STA and the second communication between the first wireless AP and the second wireless AP.

Clause 78: The first wireless AP of any of clauses 75-77, where the second wireless AP is a root AP associated with a network of wireless APs including the first wireless AP and the second wireless AP.

Clause 79: The first wireless AP of any of clauses 72-78, where the processing system is further configured to cause the first wireless AP to: receive an indication of a time-domain update to the one or more first time slots in accordance with a current arrival patten or a current periodicity associated with the first traffic flow.

Clause 80: The first wireless AP of any of clauses 72-79, where the request for the one or more coordinated time slots includes an indication of a service interval and a start time corresponding to an SLA associated with the first traffic flow or an indication of one or more requested time slots associated with the first communication of the first traffic flow between the first wireless AP and the first wireless STA.

Clause 81: A network controller, including: a processing system that includes processor circuitry and memory circuitry that stores code, the processing system configured to cause the network controller to: receive a first message that indicates a request for one or more coordinated time slots associated with a first communication of a first traffic flow between a first wireless AP and a first wireless STA associated with the first wireless AP; transmit a second message that indicates one or more first time slots associated with the first communication of the first traffic flow between the first wireless AP and the first wireless STA, where the one or more first time slots are associated with a coordinated scheduling-based protocol; and transmit a third message that indicates one or more second time slots associated with a second communication of the first traffic flow between the first wireless AP and a second wireless AP, where the one or more second time slots are associated with the coordinated scheduling-based protocol.

Clause 82: The network controller of clause 81, where the processing system is further configured to cause the network controller to: receive, via the first message, timing information associated with the first traffic flow, where the one or more first time slots or the one or more second time slots, or both, are in accordance with the timing information associated with the first traffic flow.

Clause 83: The network controller of clause 82, where the processing system is further configured to cause the network controller to: receive a fourth message that indicates one or more requested time slots associated with a third communication of a second traffic flow between a third wireless AP and a second wireless STA associated with the third wireless AP; and transmit a fifth message in association with receiving the fourth message, where a content of the fifth message is in accordance with whether the one or more requested time slots conflict with the one or more first time slots or the one or more second time slots.

Clause 84: The network controller of clause 83, where the one or more requested time slots conflict with the one or more first time slots or the one or more second time slots; and the content of the fifth message includes an indication of a time-domain adjustment to the one or more first time slots or the one or more second time slots in accordance with a second priority associated with the second traffic flow being higher than a first priority associated with the first traffic flow or the one or more requested time slots in accordance with the first priority associated with the first traffic flow being higher than the second priority associated with the second traffic flow.

Clause 85: The network controller of any of clauses 83-84, where the one or more requested time slots do not conflict with the one or more first time slots or the one or more second time slots; and the content of the fifth message includes an indication of a confirmation of the one or more requested time slots.

Clause 86: The network controller of any of clauses 82-85, where the network controller stores information indicative of the one or more first time slots, the one or more second time slots, and timing information associated with the first traffic flow in one or more memories associated with the network controller in accordance with the coordinated scheduling-based protocol; and the coordinated scheduling-based protocol at the network controller is associated with a mediation of time slot allocations across a set of multiple wireless APs at the network controller.

Clause 87: The network controller of any of clauses 81-86, where the processing system is further configured to cause the network controller to: transmit timing information associated with the first traffic flow, where the request for the one or more coordinated time slots is in accordance with the timing information associated with the first traffic flow.

Clause 88: The network controller of any of clauses 81-87, where the processing system is further configured to cause the network controller to: transmit an indication of a time-domain update to the one or more first time slots or the one or more second time slots, or both, in accordance with a current arrival patten or a current periodicity associated with the first traffic flow.

Clause 89: The network controller of any of clauses 81-88, where the request for the one or more coordinated time slots includes an indication of a service interval and a start time corresponding to an SLA associated with the first traffic flow or an indication of one or more requested time slots associated with the first communication of the first traffic flow between the first wireless AP and the first wireless STA.

Clause 90: The network controller of any of clauses 81-89, where a first time slot of the one or more first time slots is consecutive in time with a second time slot of the one or more second time slots in accordance with the first traffic flow being associated with multiple hops, and the multiple hops include the first communication between the first wireless AP and the first wireless STA and the second communication between the first wireless AP and the second wireless AP.

Clause 91: The network controller of any of clauses 81-90, where the second wireless AP is a root AP associated with a network of wireless APs including the first wireless AP and the second wireless AP.

Clause 92: A first wireless AP, including: a processing system that includes processor circuitry and memory circuitry that stores code, the processing system configured to cause the first wireless AP to: receive a first message that indicates one or more first time slots associated with a first communication of a first traffic flow between a second wireless AP and a wireless STA associated with the second wireless AP, where the one or more first time slots are associated with a coordinated scheduling-based protocol; and receive, from a network controller, a second message that indicates one or more second time slots associated with a second communication of the first traffic flow between the first wireless AP and the second wireless AP, where the one or more second time slots are associated with the coordinated scheduling-based protocol; and transmit a second message associated with an advertisement of the one or more second time slots.

Clause 93: The first wireless AP of clause 92, where the processing system is further configured to cause the first wireless AP to: receive, via the second message, timing information associated with the first traffic flow, where the one or more second time slots are in accordance with the timing information associated with the first traffic flow.

Clause 94: The first wireless AP of any of clauses 92-93, where the processing system is further configured to cause the first wireless AP to: receive, from the second wireless AP, a third message that includes timing information associated with the first traffic flow; and transmit, to the network controller, a fourth message that includes an indication of one or more requested time slots associated with the second communication of the first traffic flow between the first wireless AP and the second wireless AP in association with receiving the third message from the second wireless AP, where receiving the second message that indicates the one or more second time slots is in association with transmitting the fourth message to the network controller.

Clause 95: The first wireless AP of clause 94, where the processing system is further configured to cause the first wireless AP to: transmit the fourth message that includes the indication of the one or more requested time slots in accordance with the one or more requested time slots conflicting with one or more time slots associated with an OBSS wireless AP.

Clause 96: The first wireless AP of any of clauses 92-95, where the processing system is further configured to cause the first wireless AP to: transmit timing information associated with the first traffic flow, where the one or more first time slots or the one or more second time slots, or both, are in accordance with the timing information.

Clause 97: The first wireless AP of any of clauses 92-96, where the processing system is further configured to cause the first wireless AP to: receive an indication of a time-domain update to the one or more second time slots in accordance with a current arrival patten or a current periodicity associated with the first traffic flow.

Clause 98: The first wireless AP of any of clauses 92-97, where a first time slot of the one or more first time slots is consecutive in time with a second time slot of the one or more second time slots in accordance with the first traffic flow being associated with multiple hops, and the multiple hops include the first communication between the second wireless AP and the wireless STA and the second communication between the first wireless AP and the second wireless AP.

Clause 99: The first wireless AP of any of clauses 92-98, where the processing system is further configured to cause the first wireless AP to: communicate, with the second wireless AP, one or more first packets associated with the first traffic flow within the one or more second time slots.

Clause 100: The first wireless AP of any of clauses 92-99, where the first wireless AP is a root AP associated with a network of wireless APs including the first wireless AP and the second wireless AP.

Clause 101: A first wireless AP, including at least one means for performing a method of any of clauses 1-13.

Clause 102: A non-transitory computer-readable medium storing code for wireless communication, the code including instructions executable by a processing system to perform a method of any of clauses 1-13.

Clause 103: A network controller, including at least one means for performing a method of any of clauses 14-21.

Clause 104: A non-transitory computer-readable medium storing code for wireless communication, the code including instructions executable by a processing system to perform a method of any of clauses 14-21.

Clause 105: A first wireless AP, including at least one means for performing a method of any of clauses 22-30.

Clause 106: A non-transitory computer-readable medium storing code for wireless communication, the code including instructions executable by a processing system to perform a method of any of clauses 22-30.

Clause 107: A network controller, including at least one means for performing a method of any of clauses 31-41.

Clause 108: A non-transitory computer-readable medium storing code for wireless communication, the code including instructions executable by a processing system to perform a method of any of clauses 31-41.

Clause 109: A first wireless AP, including at least one means for performing a method of any of clauses 42-50.

Clause 110: A non-transitory computer-readable medium storing code for wireless communication, the code including instructions executable by a processing system to perform a method of any of clauses 42-50.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A first wireless access point (AP), comprising:
a processing system that includes processor circuitry and memory circuitry that stores code, the processing system configured to cause the first wireless AP to:
transmit a first message to establish one or more first time slots associated with a first communication of a first traffic flow between the first wireless AP and a first wireless station (STA) associated with the first wireless AP, wherein the one or more first time slots are associated with a coordinated scheduling-based protocol;
transmit a second message associated with an advertisement of the one or more first time slots; and
transmit, to a network controller, a third message that indicates the one or more first time slots in accordance with the advertisement of the one or more first time slots.

2. The first wireless AP of claim 1, wherein the processing system is further configured to cause the first wireless AP to:
transmit, to a second wireless AP, a request for the second wireless AP to establish time slots associated with a second communication of the first traffic flow between the first wireless AP and the second wireless AP; and
receive, from the second wireless AP, an indication of one or more second time slots associated with the second communication of the first traffic flow between the first wireless AP and the second wireless AP in association with transmitting the request, wherein the one or more second time slots are associated with the coordinated scheduling-based protocol.

3. The first wireless AP of claim 2, wherein the second wireless AP is a root AP associated with a network of wireless APs including the first wireless AP and the second wireless AP.

4. The first wireless AP of claim 1, wherein the processing system is further configured to cause the first wireless AP to:
transmit, to the network controller, information indicative of one or more requested time slots associated with a second communication of the first traffic flow between the first wireless AP and a second wireless AP; and
receive, from the second wireless AP, an indication of one or more second time slots associated with the second communication of the first traffic flow between the first wireless AP and the second wireless AP in association with transmitting the information indicative of the one or more requested time slots, wherein the one or more second time slots are associated with the coordinated scheduling-based protocol.

5. The first wireless AP of claim 4, wherein:
the one or more second time slots are advertised by the second wireless AP in accordance with the coordinated scheduling-based protocol; and
the second wireless AP is a root AP associated with a network of wireless APs including the first wireless AP and the second wireless AP.

6. The first wireless AP of claim 1, wherein the processing system is further configured to cause the first wireless AP to:
receive a fourth message that indicates one or more requested time slots associated with a communication of a second traffic flow between the first wireless AP and a second wireless STA associated with the first wireless AP; and
transmit a fifth message in association with receiving the fourth message, wherein a content of the fifth message is in accordance with whether the one or more requested time slots conflict with the one or more first time slots or one or more coordinated time slots associated with an overlapping basic service set (OBSS) wireless AP.

7. The first wireless AP of claim 6, wherein:
the one or more requested time slots conflict with the one or more first time slots; and
the content of the fifth message includes an indication of a time domain adjustment to:
the one or more first time slots in accordance with the one or more requested time slots being associated with a relatively higher priority than the one or more first time slots; or
the one or more requested time slots in accordance with the one or more first time slots being associated with a relatively higher priority than the one or more requested time slots.

8. The first wireless AP of claim 6, wherein:
the one or more requested time slots conflict with the one or more first time slots;
a bandwidth of the one or more first time slots satisfies a threshold bandwidth to accommodate the first traffic flow and the second traffic flow; and
the content of the fifth message includes an indication of a merging of the one or more requested time slots and the one or more first time slots or a confirmation of the one or more requested time slots.

9. The first wireless AP of claim 6, wherein:
the one or more requested time slots conflict with the one or more coordinated time slots associated with the OBSS wireless AP; and
the content of the fifth message includes an indication of a request for a network controller to mediate between the one or more requested time slots and the one or more coordinated time slots associated with the OBSS wireless AP.

10. The first wireless AP of claim 9, wherein the processing system is further configured to cause the first wireless AP to:
receive, from the network controller, a sixth message in association with transmitting the fifth message, wherein the sixth message indicates:
a time domain adjustment to the one or more requested time slots in accordance with the one or more coordinated time slots associated with the OBSS wireless AP associated with a relatively higher priority than the one or more requested time slots; or
a confirmation of the one or more requested time slots in accordance with the one or more requested time slots being associated with a relatively higher priority than the one or more coordinated time slots associated with the OBSS wireless AP.

11. The first wireless AP of claim 6, wherein:
the one or more requested time slots conflict with the one or more coordinated time slots associated with the OBSS wireless AP; and
the content of the fifth message includes an indication of a time domain adjustment to the one or more requested time slots.

12. (canceled)

13. (canceled)

14. A network controller, comprising:
a processing system that includes processor circuitry and memory circuitry that stores code, the processing system configured to cause the network controller to:
receive a first message that indicates one or more first time slots associated with a first communication of a first traffic flow between a first wireless access point (AP) and a first wireless station (STA) associated with the first wireless AP, wherein the one or more first time slots are associated with a coordinated scheduling-based protocol;
receive a second message that indicates one or more requested time slots associated with a second communication of a second traffic flow between a second wireless AP and a second wireless STA associated with the second wireless AP, wherein the one or more requested time slots are associated with the coordinated scheduling-based protocol; and
transmit, in accordance with a conflict between the one or more first time slots and the one or more requested time slots, a third message that indicates a time domain adjustment to the one or more first time slots or the one or more requested time slots in accordance with a first priority associated with the first traffic flow and a second priority associated with the second traffic flow.

15. The network controller of claim 14, wherein the time domain adjustment to the one or more first time slots or the one or more requested time slots comprises:
a first time domain adjustment to the one or more first time slots in accordance with the first priority being higher than the second priority; or
a second time domain adjustment to the one or more requested time slots in accordance with the second priority being higher than the first priority.

16. The network controller of claim 15, wherein the processing system is further configured to cause the network controller to:
transmit, to the first wireless AP, an indication of the first time domain adjustment to the one or more first time slots; or
transmit, to the second wireless AP, an indication of the second time domain adjustment to the one or more requested time slots.

17. The network controller of claim 16, wherein the processing system is further configured to cause the network controller to:
transmit the indication of the first time domain adjustment to the one or more first time slots via the third message; and
transmit the indication of the second time domain adjustment to the one or more requested time slots via a fourth message.

18. The network controller of claim 14, wherein:
the network controller stores information indicative of the one or more first time slots and the first priority associated with the first traffic flow in one or more memories associated with the network controller in accordance with the coordinated scheduling-based protocol; and
the coordinated scheduling-based protocol is associated with a mediation of time slot allocations across a plurality of wireless APs at the network controller.

19. The network controller of claim 14, wherein the processing system is further configured to cause the network controller to:
receive information indicative of one or more second requested time slots associated with a third communication of the first traffic flow between the first wireless AP and a third wireless AP; and
transmit, to the third wireless AP, an indication of one or more second time slots associated with the third communication of the first traffic flow between the first wireless AP and the third wireless AP in association with receiving the information indicative of the one or more second requested time slots, wherein the one or more second time slots are associated with the coordinated scheduling-based protocol.

20. (canceled)

21. (canceled)

22. A first wireless access point (AP), comprising:
a processing system that includes processor circuitry and memory circuitry that stores code, the processing system configured to cause the first wireless AP to:
transmit a first message that indicates a request for one or more coordinated time slots associated with a first communication of a first traffic flow between the first wireless AP and a first wireless station (STA) associated with the first wireless AP;
receive a second message that indicates one or more first time slots associated with the first communication of the first traffic flow between the first wireless AP and the first wireless STA in accordance with the request, wherein the one or more first time slots are associated with a coordinated scheduling-based protocol; and
transmit a third message associated with an advertisement of the one or more first time slots in accordance with receiving the second message.

23. (canceled)

24. (canceled)

25. The first wireless AP of claim 22, wherein the processing system is further configured to cause the first wireless AP to:
receive a fourth message that indicates one or more second time slots associated with a second communication of the first traffic flow between the first wireless AP and a second wireless AP, wherein the one or more second time slots are associated with the coordinated scheduling-based protocol.

26. The first wireless AP of claim 25, wherein the processing system is further configured to cause the first wireless AP to:
communicate, with the first wireless STA, one or more first packets associated with the first traffic flow within the one or more first time slots; and
communicate, with the second wireless AP, one or more second packets associated with the first traffic flow within the one or more second time slots.

27. The first wireless AP of claim 25, wherein:
a first time slot of the one or more first time slots is consecutive in time with a second time slot of the one or more second time slots in accordance with the first traffic flow being associated with multiple hops, and
the multiple hops include the first communication between the first wireless AP and the first wireless STA and the second communication between the first wireless AP and the second wireless AP.

28. The first wireless AP of claim 25, wherein the second wireless AP is a root AP associated with a network of wireless APs including the first wireless AP and the second wireless AP.

29. The first wireless AP of claim 22, wherein the processing system is further configured to cause the first wireless AP to:
receive an indication of a time domain update to the one or more first time slots in accordance with a current arrival patten or a current periodicity associated with the first traffic flow.

30. The first wireless AP of claim 22, wherein the request for the one or more coordinated time slots includes an indication of a service interval and a start time corresponding to a service level agreement (SLA) associated with the first traffic flow or an indication of one or more requested time slots associated with the first communication of the first traffic flow between the first wireless AP and the first wireless STA.

31. A network controller, comprising:
a processing system that includes processor circuitry and memory circuitry that stores code, the processing system configured to cause the network controller to:
receive a first message that indicates a request for one or more coordinated time slots associated with a first communication of a first traffic flow between a first wireless access point (AP) and a first wireless station (STA) associated with the first wireless AP;
transmit a second message that indicates one or more first time slots associated with the first communication of the first traffic flow between the first wireless AP and the first wireless STA, wherein the one or more first time slots are associated with a coordinated scheduling-based protocol; and
transmit a third message that indicates one or more second time slots associated with a second communication of the first traffic flow between the first wireless AP and a second wireless AP, wherein the one or more second time slots are associated with the coordinated scheduling-based protocol.

32. The network controller of claim 31, wherein the processing system is further configured to cause the network controller to:
receive, via the first message, timing information associated with the first traffic flow, wherein the one or more first time slots or the one or more second time slots, or both, are in accordance with the timing information associated with the first traffic flow.

33. The network controller of claim 32, wherein the processing system is further configured to cause the network controller to:
receive a fourth message that indicates one or more requested time slots associated with a third communication of a second traffic flow between a third wireless AP and a second wireless STA associated with the third wireless AP; and
transmit a fifth message in association with receiving the fourth message, wherein a content of the fifth message is in accordance with whether the one or more requested time slots conflict with the one or more first time slots or the one or more second time slots.

34. The network controller of claim 33, wherein:
the one or more requested time slots conflict with the one or more first time slots or the one or more second time slots; and
the content of the fifth message includes an indication of a time domain adjustment to:
the one or more first time slots or the one or more second time slots in accordance with a second priority associated with the second traffic flow being higher than a first priority associated with the first traffic flow; or
the one or more requested time slots in accordance with the first priority associated with the first traffic flow being higher than the second priority associated with the second traffic flow.

35. The network controller of claim 33, wherein:
the one or more requested time slots do not conflict with the one or more first time slots or the one or more second time slots; and
the content of the fifth message includes an indication of a confirmation of the one or more requested time slots.

36. The network controller of claim 32, wherein:
the network controller stores information indicative of the one or more first time slots, the one or more second time slots, and timing information associated with the first traffic flow in one or more memories associated with the network controller in accordance with the coordinated scheduling-based protocol; and
the coordinated scheduling-based protocol at the network controller is associated with a mediation of time slot allocations across a plurality of wireless APs at the network controller.

37-100. (canceled)
